(19) United States
(12) Patent Application Publication
(10) Pub. No.: US 2026/0289084 A1
(43) Pub. Date: Sep. 24, 2026

(54) SYSTEM

(71) Applicant: SoftBank Group Corp., Tokyo (JP)

(72) Inventor: Tetsuya UNO, Tokyo (JP)

(73) Assignee: SoftBank Group Corp., Tokyo (JP)

(21) Appl. No.: 19/566,994

(22) Filed: Mar. 14, 2026

(30) Foreign Application Priority Data
Mar. 19, 2025 (JP) 2025-045097

(51) Int. Cl. G06F 40/166; G06F 40/284; G06F 40/30

(52) U.S. Cl. CPC G06F 40/166; G06F 40/284; G06F 40/30

(57) ABSTRACT

A system includes a processor that is configured to provide an interface through which a user inputs information on books the user has read or wishes to read, generate a prompt sentence for summarizing contents of a book based on the input information, input the prompt sentence into a generative artificial intelligence model, receive, from the generative artificial intelligence model, a generated summary or advice based on the prompt sentence, and present information including the generated summary or the advice to the user via a display device.

### CROSS-REFERENCE TO RELATED APPLICATION

This application is based on and claims priority under 35 USC 119 from Japanese Patent Application No. 2025-045097 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that support reading activities and self-improvement typically rely on fixed, manually designed rules or static content to provide summaries, advice, or goal suggestions. Such systems require significant human effort to author and maintain content, and they are not well suited to flexibly handling diverse books, user preferences, and changing user contexts. Even when machine learning is used, many existing approaches do not fully exploit generative artificial intelligence models through dynamically constructed prompts tailored to user input, behavior, and past history. As a result, users often receive generic summaries or advice that are insufficiently personalized, and systems have difficulty proposing meaningful goals that reflect a user's long-term behavior patterns.

Accordingly, there is a need for a system that can: (i) accept information on books that a user has read or wishes to read, (ii) automatically generate suitable prompts for a generative artificial intelligence model to obtain summaries and advice, (iii) vary the advice in accordance with the user's current behavior and situation, and (iv) propose goals based on the user's past behavior and situations obtained from a database. The invention addresses the problem of providing highly personalized, context-aware summaries, advice, and goal suggestions to the user while reducing the manual effort required to design and update such content.

### SUMMARY

In order to solve the foregoing problems, the invention provides a system comprising a processor configured to provide an interface through which a user inputs information on books the user has read or wishes to read, generate a prompt sentence for summarizing contents of a book based on the input information, input the prompt sentence into a generative artificial intelligence model, receive, from the generative artificial intelligence model, a generated summary or advice based on the prompt sentence, and present information including the generated summary or the advice to the user via a display device. By automatically constructing the prompt sentence from user-provided book information, the system enables the generative artificial intelligence model to output summaries and advice suitable for a wide variety of books without manual content authoring for each book.

Furthermore, in one aspect, the processor is configured to generate a prompt that instructs the generative artificial intelligence model to vary advice in accordance with behavior or a situation of the user, input the prompt into the generative artificial intelligence model, receive, from the generative artificial intelligence model, advice varied in accordance with the behavior or the situation of the user, and present the varied advice to the user. In another aspect, the processor is configured to acquire past behavior or a past situation of the user from a database, generate a prompt that instructs the generative artificial intelligence model to propose a goal based on the past behavior or the past situation of the user, input the prompt into the generative artificial intelligence model, receive, from the generative artificial intelligence model, a proposed goal, and present the proposed goal to the user. Through these configurations, the system provides personalized, context-aware summaries, adaptive advice, and goal proposals that reflect both current and historical user information, thereby solving the above-described problems.

The term “system” refers to an arrangement including at least one processor and one or more associated components, such as memory, input devices, output devices, communication interfaces, and storage, that collectively execute the functions described in the claims.

The term “processor” refers to one or more hardware processing units, such as a central processing unit (CPU), a graphics processing unit (GPU), a microcontroller, or a combination thereof, capable of executing instructions to perform the operations recited in the claims.

The term “interface” refers to a hardware and/or software component that enables a user to input information into the system, including but not limited to graphical user interfaces, command-line interfaces, touch screens, keyboards, pointing devices, or voice input interfaces.

The term “user” refers to a human individual who operates or interacts with the system by providing input and receiving output, such as book information, summaries, advice, or proposed goals.

The term “book” refers to any work containing textual content, including but not limited to printed books, electronic books, articles, reports, or other written materials that can be read by the user.

The term “information on books the user has read or wishes to read” refers to data that identifies or describes one or more books, including, for example, a title, an author name, an ISBN, a summary, a description, personal notes, or other metadata relating to such books.

The term “prompt sentence” refers to a text string or structured textual instruction that is generated by the processor and provided to a generative artificial intelligence model in order to cause the model to produce a summary, advice, or another type of output relevant to the book information or user context.

The term “generative artificial intelligence model” refers to a machine learning model, such as a large language model or other generative model, that is capable of generating text, including summaries, advice, or goals, in response to input prompts.

The term “summary” refers to a condensed representation of the contents of a book, generated by the generative artificial intelligence model, that captures essential themes, ideas, or key points of the book.

The term “advice” refers to guidance, recommendations, or suggested actions generated by the generative artificial intelligence model, based on book information, user behavior, user situations, or past user data.

The term “display device” refers to any hardware component capable of visually presenting information to the user, including but not limited to a liquid crystal display (LCD), an organic light-emitting diode (OLED) display, a computer monitor, or a mobile device screen.

The term “behavior of the user” refers to observable or recorded actions of the user, such as reading frequency, goal completion status, interaction patterns with the system, or other activities captured by the system.

The term “situation of the user” refers to contextual information related to the user, such as time, location, schedule, current tasks, or other environmental or status-related data that may influence the advice provided by the system.

The term “past behavior or past situation of the user” refers to historical data regarding the user's actions and contexts stored over time, including previous reading activities, previously set or completed goals, and earlier contextual conditions.

The term “database” refers to a structured collection of data stored in one or more storage devices and managed by database management software or equivalent mechanisms, from which the processor can retrieve past behavior or past situations of the user.

The term “goal” refers to an objective or target proposed for the user, including short-term or long-term objectives, which may relate to reading habits, self-improvement, behavior change, or other personal development aims.

The term “propose a goal” refers to an operation in which the generative artificial intelligence model generates one or more candidate goals for the user, based on prompts constructed from the user's past behavior or past situation, and the system presents such goals to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

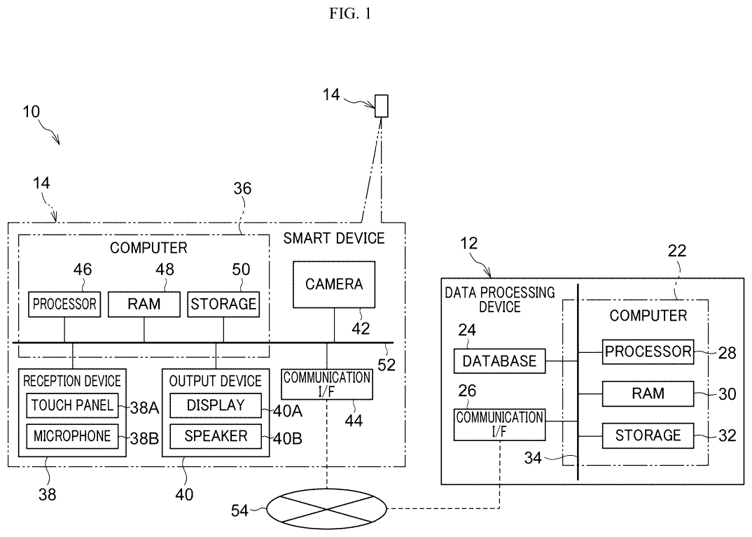

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

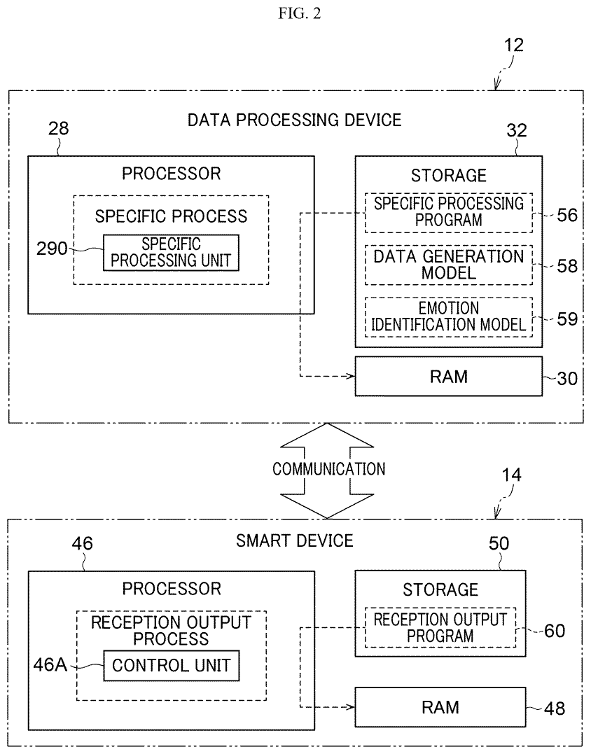

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for managing information media such as books, articles, or other content typically store only basic bibliographic information and user-entered notes. These systems generally provide static viewing and simple search functions over such stored data, but they do not integrate dynamically generated summaries, reflections, or goal-oriented advice into the underlying data structures in a way that improves the functioning of the computer system itself.

More specifically, in existing systems, any use of a generative AI model, if present at all, is usually performed as an external or ad hoc operation. The prompts supplied to the generative AI model are loosely defined, are not systematically constructed from structured relational data, and are not contextually adapted to user goals or past behavior. As a result, the generated output is not tightly integrated back into the system's persistent storage as structured relational data that can be queried, updated, and reused. This leads to several technical problems: (i) inefficient use of storage because AI-generated texts are handled as unstructured, isolated blobs; (ii) limited search and retrieval capabilities because AI output is not normalized or linked to existing relational data; (iii) increased processing overhead because similar prompts and generations are repeatedly computed without leveraging stored context; and (iv) no systematic mechanism for evolving user goals or advice based on accumulated histories, thereby underutilizing available computation and storage resources.

Furthermore, traditional systems do not provide a processor-level mechanism to generate different categories of prompts (for example, instruction prompts for summaries, advice prompts tied to goals, or goal-proposal prompts based on behavioral histories) in a programmatic and repeatable manner. This lack of structured prompt generation results in unpredictable interactions with the generative AI model, reduced reliability of outputs, and difficulty in building consistent user interfaces that can present, edit, and re-store AI-generated data as part of the system's relational data.

Accordingly, there is a need for an improved computer-implemented system that: (1) programmatically generates structured prompts for a generative AI model using relational data stored in a storage device; (2) receives AI-generated summary information, opinion information, and advice information and converts such output into editable, structured display data; (3) reintegrates the edited AI-generated data into a relational data store in a normalized and queryable form; and (4) utilizes user goals and historical usage data to construct more context-aware prompts that improve the efficiency, adaptability, and technical robustness of interactions between the system and the generative AI model. Such a system would improve the functioning of the computer itself by enabling more efficient data processing, more meaningful query operations over AI-generated content, and reduced redundancy in prompt construction and generation processing.

The specific processing by the specific processing unit 290 of the data processing device 12 in Example 1 is realized by the following means.

The present invention provides a server comprising a processor, a storage device, and a display interface, the processor being configured to generate input screens on the display interface to receive identification information and associated information regarding information media, to structure the received information as relational data and store the relational data in the storage device, to construct, based on the relational data and a user-supplied prompt sentence, categorized instruction prompts including generation instruction prompts for summary information, opinion information, and advice information, goal-oriented advice prompts based on user goals, and goal-proposal prompts based on user histories, to transmit the categorized instruction prompts to a generative AI model, to receive AI-generated text from the generative AI model, to convert the AI-generated text into editable display data, to present the editable display data on the display interface, to update the display data in response to user edit operations, and to re-store the updated display data as part of the relational data in the storage device. This enables improved computer functionality by tightly integrating generative AI interactions with structured relational storage, reducing redundancy in prompt generation, enhancing the efficiency of query and retrieval operations over AI-generated content, and providing context-adaptive processing that leverages stored user goals and histories to produce more relevant and computationally efficient outputs.

The term “system” refers to an integrated combination of one or more hardware devices and software components that cooperate to execute the processing described in the claims, including at least a processor, a storage device, and a display device.

The term “processor” refers to one or more hardware processing units, such as a central processing unit or a microprocessor, configured to execute program instructions to perform data processing, control, and communication operations described in the claims.

The term “storage device” refers to a non-transitory computer-readable medium, such as a semiconductor memory, magnetic storage, or optical storage, configured to store programs, relational data, user information, and AI-generated information used by the processor.

The term “display device” refers to an output apparatus, such as a liquid crystal display, an organic electroluminescent display, or another visual display unit, configured to present graphical user interfaces, text, and other visual information to a user.

The term “information medium” refers to any content-bearing entity, whether physical or digital, including but not limited to books, articles, documents, or electronic content items, that can be identified and described by identification information and associated information.

The term “identification information” refers to data that uniquely or semi-uniquely identifies an information medium, such as a title, an author name, a standard identifier, or other metadata suitable for distinguishing one information medium from another.

The term “associated information” refers to descriptive or contextual data related to an information medium, including user-entered summaries, impressions, notes, tags, goal-related annotations, or any additional metadata other than identification information.

The term “input screen” refers to a graphical user interface generated on the display device, including input fields, buttons, and other user interface elements, through which a user can enter, modify, or confirm identification information and associated information.

The term “relational data” refers to structured data organized in accordance with a logical schema, including records, fields, and relationships, which can be stored in and retrieved from a relational database or a functionally equivalent structured storage.

The term “query processing” refers to an operation in which the processor executes a retrieval or manipulation request, such as a selection operation or a search operation, against the relational data stored in the storage device based on one or more specified conditions.

The term “search condition” refers to a criterion or a set of criteria, such as keywords, identifiers, or logical expressions, used by the processor to limit or filter relational data during query processing.

The term “prompt sentence” refers to a natural language instruction or request entered by a user, specifying a desired operation or output to be generated by a generative AI model, such as a summary, an opinion, or advice.

The term “context information” refers to a collection of data used to provide situational or semantic background to a generative AI model, including at least a prompt sentence and one or more elements of relational data such as identification information, associated information, user goals, or user histories.

The term “generation instruction prompt” refers to a structured instruction generated by the processor, based on context information, that directs a generative AI model to produce specific types of output, including summary information, opinion information, or advice information.

The term “generative AI model” refers to a machine learning model, such as a neural network-based language model, configured to generate text or other content in response to an input prompt, by computing probabilistic outputs over sequences of tokens.

The term “summary information” refers to text generated or stored by the system that concisely represents the main points, themes, or contents of an information medium, in a shorter form than the original content.

The term “opinion information” refers to text generated or stored by the system that expresses evaluative, reflective, or interpretive content about an information medium, such as impressions, critiques, or reflections.

The term “advice information” refers to text generated or stored by the system that provides recommendations, guidance, or action suggestions to a user, potentially based on an information medium, user goals, or user histories.

The term “display data” refers to data formatted by the processor into a representation suitable for presentation on the display device, including layout, structure, and content to be visually rendered to the user.

The term “editable display data” refers to display data that is presented to the user in a form that can be modified through user interaction, such as by editing text fields, selecting options, or performing other input operations.

The term “behavioral goal” refers to a target state or objective defined by a user concerning actions or habits, such as work habits, lifestyle changes, or other behavior-related outcomes.

The term “learning goal” refers to a target state or objective defined by a user concerning acquisition of knowledge or skills, such as mastering a topic, understanding a concept, or improving expertise in a subject area.

The term “advice generation prompt” refers to a structured instruction generated by the processor, based on at least a behavioral goal or a learning goal and summary information, that directs a generative AI model to generate specific action plans or recommendations.

The term “action plan” refers to one or more concrete, executable steps or procedures generated or stored by the system, which a user can follow to move toward a behavioral goal or a learning goal.

The term “usage history” refers to data representing how a user has interacted with the system over time, including operations performed, screens accessed, and content consulted.

The term “input history” refers to data representing information that a user has entered into the system over time, including identification information, associated information, prompt sentences, and goals.

The term “behavior history” refers to data representing user behavior patterns recorded or inferred by the system, which may include interaction logs, frequency of use, or other behavior-related metrics.

The term “goal proposal prompt” refers to a structured instruction generated by the processor, based on context information including at least past history information and summary information, that directs a generative AI model to propose new goal candidates suitable for the user.

The term “goal candidate” refers to a suggested behavioral goal or learning goal generated by a generative AI model, which can be presented to the user and optionally selected or confirmed by the user.

The term “goal data” refers to structured data representing one or more goals associated with a user, including selected or confirmed goal candidates, stored in the storage device for subsequent processing and use by the system.

In one embodiment, a server, a terminal, and a user cooperate to implement the invention.

The server includes a processor, a main memory, a storage device, a network interface, and a display interface, all interconnected via an internal bus. The storage device stores an operating system, an application program for information medium management, a relational database management system, and a generative AI model serving module. The relational database may be implemented by a general-purpose relational database management system such as a structured query engine compatible with structured query language. The generative AI model serving module may access a transformer-based language model deployed on accelerator hardware such as a graphics processing unit.

The terminal includes a processor, a memory, a local storage device, a display device, and an input device such as a touchscreen. The terminal executes an application program that communicates with the server via a network such as a wireless local area network or a mobile network. The terminal application renders graphical user interfaces, acquires user input, and transmits structured requests to the server.

The user operates the terminal to register information media, such as physical books or electronic documents, and to obtain AI-generated summary information, opinion information, and advice information. The user enters identification information and associated information through input fields rendered on the terminal display device. Identification information may include a title string, an author string, or a standard identifier string. Associated information may include free-form notes, impressions, or keywords.

The terminal structures the user input into a predefined data format, such as a record object having fields for identification information and associated information. The terminal transmits this structured record to the server. The server stores the received record as relational data in a table defined in the relational database. For example, the server stores the identification information in a column for media identifiers and the associated information in a column for user annotations. The server may also store timestamps, user identifiers, and linkage keys as additional fields to support efficient indexing and join operations.

The server retrieves relational data from the storage device and constructs context information for a generative AI model. Context information includes at least one record corresponding to a selected information medium and a prompt sentence entered by the user.

The user may enter various prompt sentences on the terminal, such as:

“Please summarize this book in about 300 words, focusing on its main arguments and key concepts.”

“Please generate my personal impressions of this book in a reflective style.”

“Based on this book and my goal to improve my leadership skills, please generate concrete action steps I can take.”

“Given my goal to become more productive at work, please extract practical advice from this book and list 5 concrete actions I can start this week.”

The terminal transmits the prompt sentence along with an identifier of the corresponding record to the server. The server queries the relational database to obtain the relevant relational data, including identification information, associated information, and optionally previously generated AI output. The server then programmatically composes a generation instruction prompt for a generative AI model. In this composition, the server concatenates a system-level instruction, the identification information, the associated information, and the prompt sentence into a structured instruction message. The server may also insert delimiters and explicit role markers to indicate which portion of the text represents metadata, which portion represents user notes, and which portion represents the user's direct request.

The server employs a generative AI model implemented as a multi-layer transformer neural network. The generative AI model comprises an embedding layer, a plurality of self-attention layers, feed-forward layers, and an output layer that produces token probability distributions.

The server converts the generation instruction prompt into a sequence of tokens via a tokenizer that maps character strings to integer token identifiers. The server passes the token sequence to the generative AI model. The model processes the sequence through self-attention mechanisms in which query, key, and value vectors are computed for each token, and attention weights are calculated by scaled dot products. The model then propagates activations through multiple layers, applying non-linear activation functions and residual connections.

During inference, the server configures model parameters such as a maximum token length, a temperature parameter controlling sampling randomness, and a top-k or top-p selection strategy to balance diversity and determinism. The generative AI model outputs a sequence of tokens representing summary information, opinion information, or advice information. The server decodes the token sequence back into natural language text.

The server does not treat the generated text as an opaque blob. Instead, the server parses the generated text according to pre-defined section delimiters or markers that were required in the instruction. For example, the generation instruction prompt may require that the generative AI model output sections labeled “Key Points,” “Reflections,” and “Action Steps.”

The server splits the generated text into corresponding segments and maps each segment to specific relational fields in the database, such as an AI summary column, an AI reflection column, and an AI advice column. This mapping allows the server to store AI-generated content as normalized, structured relational data rather than as unstructured text.

The terminal acquires the AI-generated content from the server and renders editable display data. For example, the terminal displays the AI summary in a scrollable text area, the AI reflections in a separate pane, and the AI advice as a list of items with checkboxes. The user can edit the AI-generated text directly on the display device using touch or keyboard input.

The terminal transmits edited content back to the server. The server updates the corresponding relational fields with the edited content, maintaining a version history if desired. This closed-loop structure—prompt construction from relational data, AI generation, structured storage of AI output, and user feedback—improves data consistency and allows efficient query operations over AI-generated content.

The server also uses the structured relational data to construct advice generation prompts based on user goals. The user may enter a behavioral goal or a learning goal through a dedicated goal-setting screen on the terminal, such as “I want to improve my leadership skills” or “I want to understand basic probability theory.” The terminal structures this goal text and transmits it to the server. The server stores the goal in a goal table linked to user identifiers and information media identifiers. When the user requests advice, the server retrieves the goal, the AI summary of the relevant medium, and the user's associated information. The server composes an advice generation prompt that explicitly instructs the generative AI model to produce action plans tailored to the goal and the medium content. Because this prompt is constructed programmatically from stored relational data, redundant and inconsistent manual prompts are avoided, and the length and structure of the prompt are controlled to minimize token usage and network load.

In addition, the server maintains usage history, input history, and behavior history as structured records. Usage history may include logs of which media records were accessed and which AI functions were invoked. Input history may include sequences of prompt sentences previously entered by the user. Behavior history may include aggregated metrics such as the frequency of completed action plans or the time spent reading certain types of content. The server can retrieve these histories and combine them with summary information in order to construct goal proposal prompts. Such prompts instruct the generative AI model to generate candidate goals that are statistically or semantically aligned with the user's past reading patterns and actions. The generative AI model processes these prompts, and the server presents candidate goals on the terminal. The user may select or confirm one of the candidates, and the server registers the selected candidate as goal data in the storage device.

In another embodiment, the server deploys the generative AI model on a local accelerator board with dedicated memory. The server implements a batching mechanism that groups multiple generation instruction prompts into a single batch for inference. This reduces overhead of repeated model loading and improves throughput. The server also maintains a cache of attention key-value pairs for partially overlapping prompts, enabling reuse of intermediate computations when prompts share a common prefix such as shared system-level instructions and metadata format descriptions. This results in reduced inference time and lower power consumption compared to naive execution.

The system improves computer technology in several ways. First, by structuring both input data and AI-generated output as relational data with clearly defined fields, the server can execute efficient indexed queries and joins, enabling rapid retrieval of relevant AI-generated information. This contrasts with conventional systems that store AI outputs as unindexed text blobs, which require expensive full-text search operations. Second, by programmatically generating categorized prompts from relational data and user histories, the server reduces redundancy in prompt construction and avoids unnecessary network transfer of repeated context, thereby reducing communication overhead and improving response times. Third, by enforcing a schema for AI output (e.g., separate fields for summary, reflections, and action plans), the system can apply automated post-processing, such as consistency checks and length normalization, which improve the precision and usability of AI-generated content.

The server further improves accuracy and robustness by applying rule-based filters and non-conventional post-processing routines to the AI-generated text. For instance, the server may normalize numerical expressions, detect and remove duplicated sentences using similarity metrics, and enforce domain-specific constraints such as maximum action plan count or minimum coverage of key topics derived from associated information. These operations are performed algorithmically and are not mere human review automation, because they rely on systematic comparison of AI output against relational data fields and pre-defined structural expectations.

The generative AI model may be trained in advance on a corpus of text using a supervised or self-supervised learning procedure. During training, the server or an external training system minimizes a loss function such as cross-entropy between predicted token distributions and actual tokens in the corpus. Weights in the neural network are updated using gradient-based optimization algorithms such as stochastic gradient descent or adaptive moment estimation. Data augmentation techniques, such as random masking, sentence permutation, or domain-specific rephrasing, can be used to improve the generalization ability of the model. In certain embodiments, the server fine-tunes the generative AI model on anonymized user data or on synthetic prompts and outputs stored in the relational database, adjusting model parameters to better follow the structured prompts and section markers used in the system. This tight coupling between data schema, prompt structure, and model fine-tuning leads to more stable and predictable outputs, which reduces error rates and the need for manual correction.

The system employs non-conventional procedures compared to human manual summarization or advice writing. A human typically reads an entire medium, mentally summarizes it, and writes an unstructured text. In contrast, the server uses explicit relational schemas, automatic prompt composition, and transformer-based inference with attention mechanisms. The generation is shaped by algorithmically defined context packaging and post-processing, which ensures that generated outputs align with specific storage schemas and user goals. This is not a trivial automation of human work but an engineered set of computational transformations that enable the computer to handle large volumes of content, maintain consistent data structures, and provide queryable, reusable AI-generated artifacts.

In a further embodiment, the terminal maintains a lightweight local database, such as an embedded relational database, to cache recent media records and AI-generated data. The terminal synchronizes with the server when network connectivity is available, using delta-based synchronization that transfers only changed records. This reduces network bandwidth usage and allows prompt construction and partial generation to be performed offline when a smaller, distilled generative AI model is embedded in the terminal. In such a case, the terminal processor may execute a compact transformer model with fewer layers and parameters, using quantized weights to fit within the terminal's memory constraints. When connectivity is restored, the terminal can request higher-precision outputs from the server's larger generative AI model and merge them with local data.

These embodiments illustrate that the system is not limited to a single hardware or software implementation. The server may be a physical machine or a cluster of machines, and the generative AI model may be hosted on dedicated hardware or provided by an external service. The terminal may be a smartphone, a tablet, or another computing device with a display and input interface. In each case, the essential features are that the server structures user input and AI output as relational data, constructs categorized prompts from this data and user histories, drives a generative AI model with these prompts, and reintegrates the AI-generated content into the structured storage in a manner that improves processing efficiency, data management, and the technical functioning of the overall computer system.

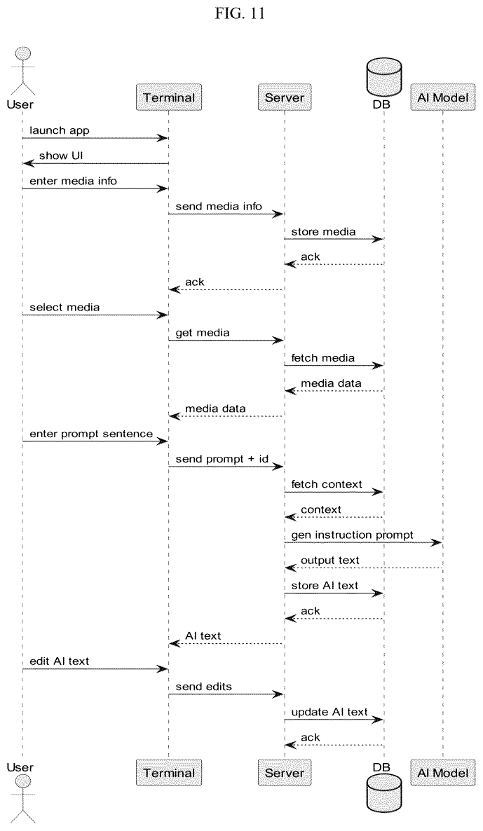

The following describes the processing flow using FIG. 11.

### Step 1

The user operates the terminal to launch an application for managing information media. The terminal loads user interface components into memory and initializes a local data structure for temporarily storing identification information and associated information. The input to this step is a launch command issued by the user (for example, a tap on an application icon), and the output is an initialized user interface displayed on the terminal screen, ready to accept user input.

### Step 2

The user uses the terminal to input identification information and associated information regarding an information medium. The input to this step is raw text typed or selected by the user, including at least a title string and optionally an author string, an identifier string, and free-form notes or impressions. The terminal receives these text values from multiple input fields, performs basic validation such as checking that required fields are not empty and that identifier formats follow a predetermined pattern, and combines the validated values into a structured record object held in memory. The output of this step is a structured record representing the information medium and associated annotations.

### Step 3

The terminal transmits the structured record to the server. The input to this step is the structured record created in Step 2. The terminal serializes the record into a message format, attaches a user identifier and a timestamp, and sends the message via a network interface using a communication protocol such as HTTPS. The output of this step is a formatted request received at the server side, containing the identification information and associated information.

### Step 4

The server receives the structured record from the terminal and stores it as relational data in a storage device. The input to this step is the serialized message containing the structured record. The server deserializes the message into internal data structures, maps each field to corresponding columns in a relational table, and executes an insertion operation through a relational database management system using a structured query language statement. The server may also generate a unique primary key value for the new record. The output of this step is a persistent relational record stored in the database and an acknowledgment, including the record identifier, sent back to the terminal.

### Step 5

The user selects an information medium on the terminal to request generated content. The input to this step is a selection action by the user, such as tapping an item in a list of stored media. The terminal associates this action with a record identifier and displays detailed information for the selected medium, including the title, author, and any existing notes. The output of this step is a detail view on the terminal that presents stored information and provides an input field for a prompt sentence.

### Step 6

The user inputs a prompt sentence on the terminal to specify a desired output from a generative AI model. The input to this step is a natural language instruction entered through a text field, such as “Please summarize this book in about 300 words, focusing on its main arguments and key concepts,” “Please generate my personal impressions of this book in a reflective style,” or “Based on this book and my goal to improve my leadership skills, please generate concrete action steps I can take.” The terminal captures this text, associates it with the selected record identifier, and stores it temporarily in memory. The output of this step is a structured request object containing the prompt sentence and a reference to the information medium.

### Step 7

The terminal sends the prompt sentence and context identifiers to the server. The input to this step is the structured request object from Step 6. The terminal constructs a network request including a user identifier, a record identifier, and the prompt sentence, serializes these fields into a message format, and transmits the message via the network interface. The output of this step is a server-side request containing the prompt sentence and identifiers needed to retrieve context.

### Step 8

The server retrieves relational data corresponding to the selected information medium and constructs context information. The input to this step is the server-side request containing the record identifier and the prompt sentence. The server executes a selection query on the relational database to obtain stored identification information, associated information, and any previously stored AI-generated content for that record. The server then combines these values with the prompt sentence into a context object, which may contain fields for metadata, user notes, and user instructions. The output of this step is a fully populated context object ready for prompt construction.

### Step 9

The server generates a generation instruction prompt for the generative AI model based on the context information. The input to this step is the context object generated in Step 8. The server applies a predetermined template to arrange metadata, associated information, and the prompt sentence in a structured order, inserting labels and separators that clearly delineate sections such as “Media Information,” “User Notes,” and “User Request.” The server may also add system-level instructions specifying constraints such as output length, style, and required sections in the response. The output of this step is a single composite instruction string, called a generation instruction prompt, that encapsulates all necessary context for the generative AI model.

### Step 10

The server converts the generation instruction prompt into a token sequence and inputs it to the generative AI model. The input to this step is the composite instruction string from Step 9. The server uses a tokenizer to map the string into a sequence of integer token identifiers, performing operations such as subword segmentation and vocabulary lookup. The server arranges these token identifiers into a tensor suitable for processing by a transformer-based neural network and passes the tensor to an inference engine running on a processor such as a general-purpose processor or a graphics processing unit. The output of this step is an internal representation of the input sequence within the generative AI model's computation graph.

### Step 11

The generative AI model processes the token sequence to generate output tokens representing summary information, opinion information, or advice information. The input to this step is the embedded token sequence residing in the model's input layer. The model performs multiple rounds of data processing, including computing query, key, and value vectors, calculating attention scores via matrix multiplications, applying nonlinear transformations in feed-forward layers, and computing probability distributions over the vocabulary for each output position. The server iteratively samples or selects the most probable tokens under configured parameters, such as maximum token length, temperature, and top-k or top-p thresholds. The output of this step is a sequence of output token identifiers corresponding to generated natural language text.

### Step 12

The server decodes the output token sequence into natural language text and parses it into structured segments. The input to this step is the sequence of output token identifiers from Step 11. The server applies a detokenization procedure to map the identifiers back to characters and words, yielding a text string. If the generation instruction prompt required labeled sections, the server scans the text for such labels and separators and splits the text into multiple segments, such as a summary segment, a reflection segment, and an action-plan segment. The server assigns each segment to a corresponding field in an internal data structure representing AI-generated content. The output of this step is a structured AI-generated content object containing one or more text segments.

### Step 13

The server stores the structured AI-generated content as relational data and prepares display data. The input to this step is the structured AI-generated content object from Step 12 and the record identifier linking it to an information medium. The server constructs update statements or insertion statements to place each segment into specific columns of the relational database, such as an AI summary column, an AI opinion column, and an AI advice column. The server executes these database operations and commits the changes. The server also generates display data by applying formatting rules, such as adding headings and converting bullet items into list representations. The output of this step is updated relational data in the storage device and formatted display data prepared to be sent to the terminal.

### Step 14

The server transmits the formatted display data to the terminal. The input to this step is the prepared display data from Step 13. The server serializes the display data into a response message, associates it with the corresponding record identifier and user identifier, and sends it via the network interface using a response protocol. The output of this step is a received response message at the terminal side containing the AI-generated text segments and layout hints.

### Step 15

The terminal renders the display data and allows user editing. The input to this step is the response message containing formatted display data from Step 14. The terminal deserializes the message, maps each text segment to specific user interface components such as scrollable text areas and lists, and displays them on the screen. The terminal enables editing functions, allowing the user to place the cursor inside the AI-generated text, modify wording, delete sentences, or add new content. The output of this step is an updated version of the AI-generated text maintained in the terminal's memory, reflecting any edits performed by the user.

### Step 16

The terminal sends edited AI-generated content back to the server for persistent storage. The input to this step is the edited text segments held in memory after user interaction. The terminal compares the edited content with the originally received content, constructs a structured update message containing only changed segments, and includes the record identifier and optional version information. The terminal then transmits this update message via the network interface. The output of this step is an update request received by the server containing edited AI-generated content.

### Step 17

The server updates relational data based on the edited AI-generated content. The input to this step is the update request from Step 16. The server parses the request, determines which segments have changed, and generates corresponding update statements for the relational database. The server executes these statements, replacing previous AI-generated values with edited values in the appropriate columns, and optionally records revision metadata such as edit timestamps and editor identifiers. The output of this step is a revised set of relational records that now store the final, user-confirmed AI-generated content.

### Step 18

The user optionally defines a behavioral goal or learning goal on the terminal for the selected information medium. The input to this step is text entered by the user into a goal-setting field, such as “I want to improve my leadership skills” or “I want to understand basic probability theory.” The terminal structures this text into a goal record associated with the user identifier and the information medium identifier. The output of this step is a structured goal record stored locally or sent to the server for persistent storage.

### Step 19

The server uses stored goals and historical data to construct an advice generation prompt or goal proposal prompt. The input to this step is relational data representing user goals, usage history, input history, behavior history, and AI-generated summary information for the selected medium. The server executes database queries to retrieve these records and applies algorithmic rules to select relevant elements, such as media most frequently consulted or goals not yet addressed by any action plan. The server then composes a prompt that includes this historical context and explicitly instructs the generative AI model to output specific action plans or new goal candidates. The output of this step is a context-rich advice generation prompt or goal proposal prompt that is passed to the generative AI model as in Steps 10 and 11, resulting in tailored advice or proposed goals to be returned to and displayed on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content recommendation systems and summary generation systems typically treat user-provided book information as static metadata and apply fixed, heuristic matching rules or pre-trained models without dynamic control over the models'internal behavior. Such systems often (i) rely on simple keyword matching against catalog data, (ii) separate summary generation from recommendation processing without a unified control mechanism, and (iii) fail to exploit user interaction feedback in a structured way to adapt the interaction with a generative AI model. As a result, existing systems suffer from several technical limitations in computer-based information processing.

First, conventional systems do not provide a systematic mechanism for generating and updating machine-consumable prompt sentences that explicitly instruct a generative AI model how to analyze user-specific attribute information and impression information, and how to output recommendation-ready data. The generative AI model is often used in a generic text-completion manner, which leads to outputs that are difficult for a processor to parse and integrate into a recommendation pipeline. This causes inefficiencies in server-side processing, increased post-processing overhead, and unstable system behavior.

Second, existing systems lack a technical architecture for tightly coupling user behavior logs and context information, on the one hand, with the generation of prompt sentences and the selection or ranking of recommended resources, on the other hand. User feedback, such as clicks or selections, is frequently stored only as analytics data and is not directly incorporated into the computational control flow that governs subsequent interactions with the generative AI model. Consequently, the system is unable to iteratively refine its prompt generation logic and recommendation logic at the processing level, which results in poor personalization and suboptimal use of computing resources.

Third, most known systems do not provide a unified, processor-level mechanism by which a server can dynamically change advice content, recommendation policies, and even proposed user goals or action plans by modifying the structure and parameters of prompt sentences supplied to a generative AI model. Because the instructions to the model are not programmatically structured as part of the core server logic, the system cannot reliably achieve consistent behavior across different sessions and users, nor can it efficiently adapt to changing user states in real time.

Accordingly, there is a need for a computer-implemented technique that improves the functioning of a server-based information processing system by: (i) programmatically generating structured prompt sentences based on stored attribute information, impression information, and user behavior data; (ii) using a generative AI model as a controllable computational component within the server's processing pipeline; and (iii) feeding back user interaction data into both prompt generation and recommendation selection or ranking, thereby improving the accuracy, stability, and efficiency of recommendation and advice generation in a technical manner.

The specific processing by the specific processing unit 290 of the data processing device 12 in Application Example 1 is realized by the following means.

The present invention provides a server comprising a processor and a storage device, the processor being configured to receive, from a terminal, attribute information and impression information regarding an information medium that a user has read or intends to read, store the attribute information and the impression information in the storage device, generate a structured prompt sentence based on the stored attribute information and impression information so as to cause a generative AI model to analyze contents of the information medium and preferences of the user, input the structured prompt sentence into the generative AI model to acquire generated information including a recommendation result for related information resources, identify the related information resources based on the generated information, acquire past behavior information and context information of the user from the storage device, generate recommendation information by selecting or ranking the related information resources using the past behavior information and the context information, transmit the recommendation information to the terminal to be presented to the user, and further acquire, from the terminal, selection operation information performed by the user on at least one of the related information resources, store the selection operation information as feedback information in the storage device, and adapt at least one of subsequent generation of the structured prompt sentence and subsequent selection or ranking of the related information resources based on the feedback information. This enables the server to implement an improved computer-implemented recommendation architecture in which the generative AI model is programmatically controlled through dynamically generated prompt sentences, user feedback is directly incorporated into the model interaction and ranking logic, and overall system performance is enhanced in terms of personalization accuracy, processing stability, and computational efficiency.

The term “processor” refers to a hardware or virtual information processing element, such as a central processing unit or a processing core, that executes computer-readable instructions to perform the functions described in the system.

The term “storage device” refers to a hardware or virtual data retention component, such as a memory device or a database system, that stores attribute information, impression information, behavior information, context information, recommendation information, and feedback information for use by the processor.

The term “terminal” refers to an information processing apparatus operated by a user, such as a client device including a display device and an input interface, that transmits information to the server and receives information from the server.

The term “user” refers to an operator of the terminal who provides information medium-related information and receives recommendation information or advice generated by the system.

The term “information medium” refers to content that is the subject of user interest or consumption, including at least a textual work, an audio work, a visual work, or a digital publication, which may be represented by attribute information and impression information.

The term “attribute information” refers to structured descriptive data regarding an information medium, including at least one of a title, an author identifier, a classification identifier, or a genre identifier.

The term “impression information” refers to user-provided descriptive data expressing a perception of or reaction to an information medium, including at least one of a summary text, an opinion text, or a free-form comment.

The term “prompt sentence” refers to a machine-consumable instruction text generated by the processor, which encodes attribute information, impression information, and control directives, and is supplied to a generative AI model to cause the generative AI model to perform a specified analysis or generation task.

The term “structured prompt sentence” refers to a prompt sentence having a controlled format or structure, such as predefined sections or fields, that enables the processor to systematically influence the behavior of the generative AI model and to facilitate post-processing of the generated information.

The term “generative AI model” refers to a machine learning model configured to generate output data, such as natural language text, in response to an input including a prompt sentence, and implemented for example as a neural network-based model capable of content analysis and content generation.

The term “generated information” refers to output data produced by the generative AI model in response to a prompt sentence, including at least a recommendation result, advice content, proposed targets, or action policies.

The term “recommendation result” refers to part of the generated information that indicates one or more candidate related information resources associated with an information medium or with a user preference.

The term “related information resources” refers to content items, such as digital media items, publications, or other information entities, that are determined by the processor, based on the generated information, to be associated with an information medium or with a user preference.

The term “recommendation information” refers to structured data generated by the processor that specifies a set of related information resources selected or ranked for presentation to the user, optionally including metadata such as titles, descriptions, and identifiers.

The term “past behavior information” refers to data indicating historical user interactions with information resources or system outputs, including at least one of view events, selection events, purchase events, or dwell time information.

The term “context information” refers to data representing a usage environment or state associated with the user or the terminal, including at least one of time information, device type information, location category information, or session state information.

The term “selection operation information” refers to data indicating an operation performed by the user on at least one of the related information resources, including at least one of a click event, a tap event, a selection event, or an ignore event.

The term “feedback information” refers to data stored in the storage device that is derived from selection operation information or past behavior information and is used to adapt subsequent prompt sentence generation and subsequent selection or ranking of related information resources.

The term “advice contents” refers to generated information that provides the user with guidance, commentary, or evaluative statements related to information resources, preferences, or goals.

The term “recommendation policies” refers to computational rules or strategies, implemented by the processor, that govern selection, ranking, or filtering of related information resources in response to the generated information and feedback information.

The term “achievement target” refers to a goal proposed for a user, derived at least in part from past behavior information and context information, and generated via the generative AI model in response to a prompt sentence.

The term “action policy” refers to a recommended course of action or plan of behavior proposed for the user in relation to information resources or achievement targets, generated via the generative AI model in response to a prompt sentence.

The server implements the invention by executing a program on one or more processors that cooperate with a storage device, one or more communication interfaces, and one or more terminals operated by a user. The server executes computer-readable instructions stored in the storage device to perform the functions defined in the claims and described below.

The server includes a network interface, a main processor such as a central processing unit or a graphics processing unit, and a storage device such as a main memory and a persistent database system. The server connects to terminals, for example smartphones, tablet computers, or personal computers, over a communication network such as the Internet using a protocol such as HTTPS. The server runs an application framework, for example a web application framework implemented in a general-purpose programming language, and provides an application programming interface that the terminals invoke.

The terminal includes a display device, an input interface, and a communication interface. The terminal executes a client application, for example a web browser application or a native mobile application, and renders a graphical user interface. The terminal presents input fields for attribute information and impression information of an information medium. The terminal transmits the input data to the server in a structured format, such as a JavaScript Object Notation object, via the communication interface.

The user operates the terminal to input attribute information and impression information regarding an information medium that the user has read or intends to read. The user types a title, a category label, a genre label, or a textual summary and opinion into the input fields presented on the terminal. The user triggers transmission of the input data, and the terminal sends a request including the input data and optional authentication information to the server.

The server receives the request via the network interface and parses the structured data. The server stores the attribute information and impression information in the storage device in association with a user identifier. The server uses a database engine, for example a relational database engine, and writes data records including fields such as user identifier, information medium identifier, title, genre, summary text, and opinion text. The server defines indexes over key fields such as user identifier and genre to accelerate subsequent retrieval operations.

The server generates a prompt sentence based on the stored attribute information and impression information. The server constructs the prompt sentence using a template mechanism. The server stores one or more prompt templates in the storage device. Each template includes fixed instruction text and placeholder tokens. The server retrieves a selected template from the storage device and substitutes the placeholder tokens with specific attribute information and impression information. The server thereby generates a structured prompt sentence with a controlled section order and explicit instruction phrases to constrain an output format of a generative AI model.

The server, for example, generates a prompt sentence such as:

“The user has entered the following book information:

Title: ‘The Dragon's Path’

Genre: ‘fantasy novel’

User impressions: ‘I like complex world-building and political intrigue.’

Based on this information, analyze what the user is likely to enjoy and recommend:
(1) five related e-books,
(2) three relevant audiobooks, and
(3) three movies or documentaries about fantasy worlds.

Provide the output as a numbered list with a short explanation for each item.”

The server uses this structured prompt sentence as input to a generative AI model. The server may deploy the generative AI model locally or access the model via a remote service. In one embodiment, the generative AI model is an auto-regressive neural network model using a transformer architecture. The model receives a sequence of tokens representing the prompt sentence, converts each token into an embedding vector using an embedding layer, and processes the sequence with a plurality of transformer blocks.

The server configures the generative AI model with an input embedding dimension, a number of attention heads, and a number of transformer layers. Each transformer block performs multi-head self-attention using learned weight matrices and applies a position-wise feedforward network followed by normalization layers. The model computes attention scores as scaled dot products of query and key vectors, applies a softmax function to obtain attention weights, and produces attention-weighted context vectors that capture semantic relationships between tokens. The model stacks such layers to obtain high-dimensional representations of the entire prompt sentence and generates output tokens sequentially by computing probability distributions over a token vocabulary and selecting tokens according to sampling parameters such as temperature and top-k or top-p constraints.

The server controls generation behavior by specifying model parameters such as maximum token length, temperature, sampling strategy, and stop sequences. The server thereby restricts the range and structure of output text, which reduces post-processing complexity and increases determinism of the recommendation pipeline. The server sets these parameters adaptively based on content type or user profile, which constitutes a technical control flow distinct from human manual prompting.

The server receives generated information from the generative AI model in the form of a text output sequence. The server parses the generated information according to the predefined structure specified in the prompt sentence. The server uses text parsing algorithms such as regular expression matching and delimiter-based segmentation to separate numbered items and to extract titles, content types, and short descriptions. The server maps natural language labels such as “e-book,” “audiobook,” or “movie” to internal type codes stored in the storage device.

The server optionally enriches the parsed recommendation items by querying additional data sources. The server may call external catalog services via further network requests, or may search a local catalog database, to verify item existence, retrieve identifiers, and normalize metadata. The server updates the storage device with normalized related information resources including identifiers, titles, content types, and links.

The server generates recommendation information by selecting and ranking the related information resources. The server retrieves past behavior information and context information from the storage device. The server maintains for each user a profile record that includes, for example, counters of selected items per genre, average dwell time per content type, and click-through rates for prior recommendations. The server computes a relevance score for each related information resource using a scoring function that combines signals such as similarity between a resource genre and a user's preferred genres, recency of similar selections, and match between resource format and previously preferred formats.

In one embodiment, the server computes a score as a weighted sum of normalized feature values, where weights are stored in the storage device and updated periodically using a gradient-based optimization procedure. The server may pre-compute embedding vectors for genres or topics and may use cosine similarity between these vectors as a feature. The server ranks the related information resources by descending score and truncates the list to a limited number to reduce communication load. The server stores the final recommendation information and associated scores in the storage device together with an identifier that links the recommendation to the original input information medium and prompt sentence.

The server transmits the recommendation information to the terminal via the network interface. The server formats the data as structured response data and includes identifiers, titles, content types, and descriptions. The terminal receives the recommendation information and updates the display device to present a list of related information resources. The terminal may display icons indicating resource type and may present additional controls, such as sorting or filtering operations, implemented in the client application.

The user reviews the presented recommendation information and selects one or more related information resources by performing operations on the input interface of the terminal. The terminal captures such selection operations as events including resource identifiers, timestamps, and operation types, and transmits the events to the server.

The server receives the selection operation information and stores it in the storage device as feedback information. The server updates the user profile and aggregates feedback statistics. The server modifies parameters of the scoring function and parameters used to construct future prompt sentences. For example, the server increases weights associated with subject tags that frequently appear in selected items and decreases weights for subject tags that appear predominantly in ignored items. The server also adjusts prompt templates to emphasize user-preferred characteristics. The server may revise a future prompt sentence from a generic form to a more specific form such as:

“The user prefers dark fantasy novels with complex politics. The current book genre is ‘fantasy novel’. Recommend e-books, audiobooks, and movies that match dark fantasy and political intrigue, avoiding light-hearted or comedic works.”

The server therefore uses feedback information to alter the content and structure of prompt sentences as well as ranking logic in a programmatic manner that is not achievable by static rule-based systems or manual human prompting. The server's prompt generation mechanism encodes feedback-driven constraints and preferences explicitly in machine-consumable form, enabling the generative AI model to generate outputs that are better aligned with structured ranking algorithms.

The server implements the generative AI model training or fine-tuning process in some embodiments. The server collects a set of training examples consisting of prompt sentences, user feedback signals, and target output patterns. The server represents each example as a sequence of tokens and uses a training procedure to update model parameters. The server defines a loss function, for example a cross-entropy loss between predicted token distributions and target tokens, and uses a gradient descent algorithm with an optimizer such as Adam. The server computes gradients of the loss function with respect to model parameters via backpropagation through the transformer layers and updates the parameters based on the gradients. The server may apply regularization techniques such as dropout and layer normalization to improve generalization. The server may also perform data augmentation by varying template wording while preserving semantic structure to make the model robust to template variations.

The server thus implements model-specific processing that uses machine-learned attention patterns and high-dimensional embeddings to capture subtle relationships between attribute information, impression information, and user profiles. The server's combination of template-based prompt generation, transformer-based inference, structured post-processing, and feedback-driven adaptation yields a computational flow that reduces the need for expensive manual rule engineering and improves prediction accuracy compared to simple keyword-based retrieval.

The server achieves several technical effects in the operation of the computer system. The server reduces processing time for generating high-quality recommendations by using structured prompt sentences that constrain the generative AI model's output format, thereby simplifying parsing and reducing the number of correction passes. The server improves accuracy of recommendations by integrating user feedback directly into both the input space of the generative AI model and the ranking space of the recommendation algorithm. The server reduces storage and communication overhead by selectively storing and transmitting only ranked and filtered recommendation information instead of raw, verbose generated text.

The server further improves data management by maintaining explicit data structures for attribute information, impression information, past behavior information, context information, prompt templates, and recommendation information. The server uses indexed database tables or key-value stores, which decrease query latency when retrieving user-specific information for subsequent processing. The server thereby enhances computational efficiency by minimizing redundant data access and reducing the number of network calls needed during recommendation generation.

The server differs from a mere automation of human tasks. A human user cannot feasibly perform high-dimensional vector calculations, transformer-based attention mechanisms, and large-scale aggregation of multi-user feedback in real time. The server uses specialized numerical routines and optimization algorithms that are not part of conventional human cognitive workflows. The server enforces specific, non-conventional processing steps, such as dynamic prompt template selection based on quantized feedback features, adaptive tuning of sampling parameters for the generative AI model, and joint optimization of prompt structure and ranking weights. These steps constitute technical processing on digital data that improves the operation of the computer system itself.

The server can be implemented in various embodiments. In one embodiment, the server deploys the generative AI model on a dedicated computation node equipped with tensor processing hardware, and a separate application node handles request routing and storage access. In another embodiment, the server uses a managed model hosting service and executes only prompt generation and post-processing logic locally. The terminal can be any device capable of running a client application and connecting to the network, such as a smartphone, a tablet, a notebook computer, or a dedicated reading device.

The server may use alternative model architectures in additional embodiments. For example, the server may use an encoder-decoder architecture with attention to encode attribute information and impression information into a latent representation and decode the representation into recommendation text. The server may also use hybrid models that combine transformer-based sequence encoders with separate feedforward networks that compute ranking scores. The server can store pre-computed embeddings of information resources and compute nearest neighbors in vector space to further constrain input to the generative AI model, thus reducing computational load and improving response time.

The server can also vary the level of personalization. In one variation, the server includes only aggregate behavior statistics over a population in prompt sentences, thereby generating recommendations that reflect community trends. In another variation, the server includes detailed personal preference vectors derived from individual user histories. The server selects between these modes based on resource constraints, privacy settings, or application domain.

The server may also support different kinds of information media, such as audio content, video content, or mixed media. The server adapts prompt templates to include modality-specific cues, such as “focus on long-form audio lectures” or “recommend short-form educational videos,” and updates ranking features accordingly, for example by incorporating average listening completion rates or video watch times.

Through these configurations and variations, the server provides a concrete, technical implementation that uses a generative AI model and structured prompt sentences to control and improve the behavior of an information processing system. The server thereby enhances recommendation precision, computational efficiency, and stability of system behavior, and offers an improved computer-based solution over conventional systems that rely on static rules or unstructured interactions with generative models.

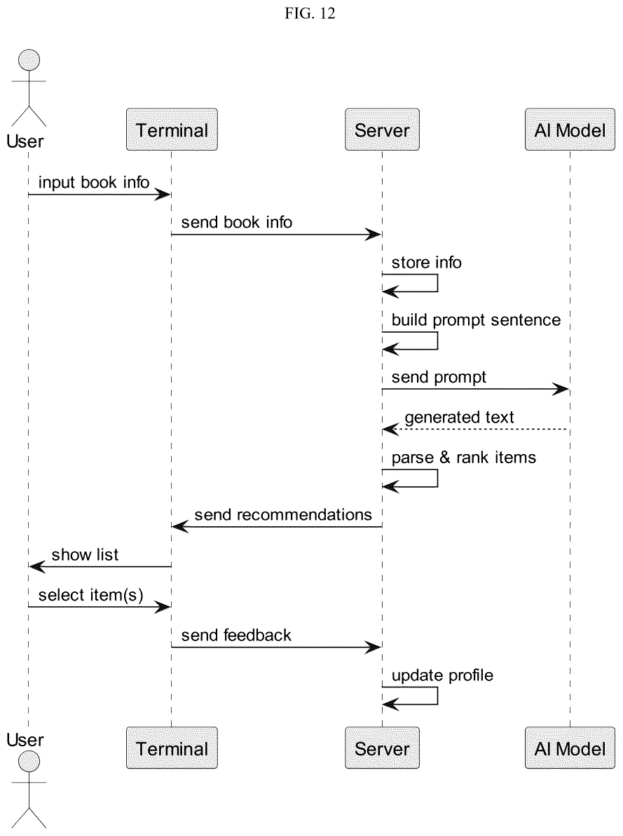

The following describes the processing flow using FIG. 12.

### Step 1

The user operates the terminal to input attribute information and impression information.

The user enters, as input, data such as a title, a genre label, a classification identifier, a summary text, and an opinion text into input fields displayed on the terminal. The terminal collects these values from the graphical user interface components, validates required fields (for example, checks that the title is not empty), and constructs a structured data object including user identifier, attribute information, and impression information as output. The terminal then prepares this structured data object for transmission to the server.

### Step 2

The terminal transmits the structured data object to the server.

The terminal uses the communication interface to send, as input to the server, a network request containing the structured data object and optional authentication information. The terminal encodes the data in a predefined interchange format and sends it over a secure transport protocol. The output of this step is a network message delivered to the server that encapsulates the user identifier, attribute information, and impression information in a machine-readable form.

### Step 3

The server receives and stores the attribute information and impression information.

The server accepts, as input, the network message from the terminal and decodes the structured data object. The server parses fields such as title, genre, summary text, and opinion text, and performs data type checks and length checks. The server writes these parsed values into records in the storage device, associating them with a user identifier and a newly generated information medium identifier. The server uses a database engine to execute insert operations and to update index structures. The output of this step is a set of persistent records stored in the storage device, accessible via the information medium identifier.

### Step 4

The server retrieves stored information and selects a prompt template.

The server reads, as input, the information medium identifier and user identifier associated with the most recent request. The server issues database queries to the storage device to retrieve the corresponding attribute information and impression information. The server then loads, from a template repository in the storage device, a predefined prompt template that matches the type of information medium or the application scenario. The server may select among multiple templates based on genre or usage context. The output of this step is a combination of retrieved user-specific data and a selected prompt template ready for instantiation.

### Step 5

The server generates a structured prompt sentence.

The server takes, as input, the selected prompt template and the retrieved attribute information and impression information. The server performs placeholder substitution by replacing template tokens (such as “{TITLE}”, “{GENRE}”, “{IMPRESSIONS}”) with actual text values stored in the records. The server concatenates text segments in a predetermined order and may append explicit instructions about output format and content categories. This text processing produces, as output, a structured prompt sentence that encodes both the user-provided information and control directives for the generative AI model.

### Step 6

The server invokes the generative AI model with the prompt sentence.

The server receives, as input, the structured prompt sentence and a configuration of generation parameters such as maximum token length and sampling temperature. The server tokenizes the prompt sentence into tokens and sends the tokenized sequence and configuration parameters to the generative AI model, either locally or via a network interface to a model-hosting service. Inside the model, a sequence of numerical operations is performed: each token is converted to an embedding vector, transformer layers compute attention-based representations, and output token probability distributions are computed. The server requests generation of a sequence of output tokens until a stop condition is reached. The output of this step is a generated text sequence returned to the server as generated information.

### Step 7

The server parses the generated information into candidate related information resources.

The server takes, as input, the generated text sequence produced by the generative AI model. The server applies text parsing rules, such as splitting the text by numbered list markers or line breaks, and uses pattern matching to extract candidate titles, inferred content types (for example, e-book, audiobook, movie), and short descriptions. The server normalizes these extracted values, for example by trimming whitespace and standardizing case. The output of this step is a list of candidate related information resources represented as internal data objects containing fields for title, type, and description.

### Step 8

The server enriches and normalizes the candidate related information resources.

The server receives, as input, the list of candidate related information resource objects. The server may query local catalog tables in the storage device or external catalog services using title and type as search keys. The server matches candidate items to catalog entries using string similarity or identifier mapping and retrieves normalized metadata such as unique resource identifiers, standardized titles, and access links. The server updates each candidate object with matched metadata and discards items that do not meet validity criteria. The output of this step is a refined list of related information resources with normalized identifiers and metadata.

### Step 9

The server computes relevance scores using past behavior information and context information.

The server takes, as input, the refined list of related information resources, the user identifier, and current context information such as a timestamp or device type. The server queries the storage device for past behavior information, including historical selection events and interaction statistics for the user. The server computes feature values for each related information resource, such as genre match to user preferences, similarity to previously selected items, and alignment with preferred content types. The server applies a scoring function, for example a weighted sum or a learned model, to derive a numerical relevance score for each resource. The output of this step is the list of related information resources augmented with relevance scores.

### Step 10

The server generates recommendation information by selecting and ranking related information resources.

The server accepts, as input, the scored list of related information resources. The server sorts the list in descending order of relevance score and applies selection criteria, such as limiting the number of items per content type or applying minimum score thresholds. The server constructs a recommendation information object that includes selected items with their titles, types, descriptions, identifiers, and scores. The server stores this recommendation information in the storage device linked to the original information medium identifier. The output of this step is a finalized recommendation information object ready for transmission to the terminal.

### Step 11

The server transmits the recommendation information to the terminal.

The server takes, as input, the recommendation information object. The server formats the object into a response structure and sends it over the network interface to the terminal associated with the user identifier. The server may compress the response or remove nonessential fields to reduce payload size. The output of this step is a network response message delivered to the terminal that encapsulates the recommendation information.

### Step 12

The terminal presents the recommendation information to the user.

The terminal receives, as input, the network response message from the server and decodes the contained recommendation information. The terminal updates the graphical user interface by generating display elements for each related information resource, including textual labels and icons corresponding to content types. The terminal arranges the items in a ranked list or grid according to the order determined by the server. The output of this step is a visual representation of the recommendation information rendered on the display device for the user.

### Step 13

The user selects one or more related information resources on the terminal.

The user observes, as input, the recommendation list displayed on the terminal and performs selection operations such as tapping or clicking on items of interest. The terminal detects these user actions through the input interface and associates operations with resource identifiers and timestamps. The terminal produces, as output, selection operation information that records which items were selected, which were ignored, and possibly how long each item was viewed.

### Step 14

The terminal transmits selection operation information to the server.

The terminal uses the communication interface to send, as input to the server, a feedback message containing selection operation information for each user action. The terminal may batch multiple events to reduce communication overhead and annotate each event with session identifiers. The output of this step is a feedback network message delivered to the server.

### Step 15

The server stores selection operation information as feedback information.

The server receives, as input, the feedback message containing selection operation information. The server parses each event to extract resource identifiers, operation types, and timestamps, and writes these data into feedback records in the storage device. The server organizes feedback records in tables indexed by user identifier and resource identifier to enable efficient retrieval. The output of this step is an updated set of feedback information stored persistently.

### Step 16

The server updates user profiles and ranking parameters based on feedback information.

The server takes, as input, the newly stored feedback information and existing user profile data from the storage device. The server aggregates statistics such as counts of selections per genre and success rates of prior recommendations. The server adjusts internal ranking parameters, such as weights assigned to genre match or content type preferences, using an update rule or optimization algorithm. The server also updates user preference vectors, if maintained, to reflect shifts in interest. The output of this step is an updated user profile and a revised set of ranking parameters stored in the storage device.

### Step 17

The server adapts future prompt sentence generation using updated feedback-derived data.

The server receives, as input, the updated user profile and ranking parameters. The server selects or modifies prompt templates to emphasize user-preferred characteristics, such as specific sub-genres or narrative elements, by updating template segments or inserting additional instruction clauses. When the server next generates a prompt sentence, the server incorporates these updated preferences and constraints into the structured prompt sentence. The output of this step is an adapted prompt generation configuration that will cause subsequent prompt sentences to be more aligned with the user's actual behavior and context.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented book analysis and recommendation systems, a processor typically applies shallow keyword extraction or generic summarization algorithms directly to raw text. Such systems suffer from several technical shortcomings.

First, conventional systems often process user-provided book text as an undifferentiated character sequence without applying structured natural language preprocessing, such as morphological segmentation, removal of non-informative terms, and normalization of word forms, in a coordinated manner tailored to downstream theme extraction. As a result, the internal text representation used by the computer is noisy and redundant, which degrades the accuracy and stability of automated theme detection and message extraction. This leads to increased processing overhead to compensate for noise, and suboptimal use of computational resources in the processor and memory subsystem.

Second, existing systems typically invoke a generative AI model with static, coarse-grained instructions that do not distinguish between different analytical stages (for example, theme extraction, summary generation, goal and advice generation). Because the same generic prompt is reused for multiple purposes, the generative AI model cannot efficiently specialize its computation to each analytical task. This reduces the determinism and reproducibility of the generated outputs, increases the number of trial-and-error calls to the generative AI model, and therefore increases latency and processing cost on the server side.

Third, many systems are not configured to integrate user-specific behavioral information and situational information into the prompt sentences supplied to the generative AI model. Instead, advice and recommendations are generated in a user-agnostic manner. This causes the processor to discard structured user context that is already stored in the system and forces the generative AI model to infer context implicitly from the book text alone. As a consequence, the system cannot efficiently generate advice that is technically adapted to stored user state, leading to redundant recomputation and ineffective personalization logic.

Fourth, conventional systems do not clearly decompose the interaction with the generative AI model into multiple prompt sentences that correspond to distinct processing stages, such as (i) extraction of main themes and messages from preprocessed text, (ii) generation of a summary and generic advice based on those themes, and (iii) generation of user-adapted goals and action plans based on user behavioral histories. This lack of modular prompt design prevents the processor from reusing intermediate AI outputs, reduces the ability to cache and index intermediate representations, and ultimately results in inefficient workflows, higher bandwidth usage, and a less predictable computational profile.

Accordingly, there is a need for a computer-implemented technique that improves the way a processor structures and preprocesses book-related text, orchestrates interactions with a generative AI model through stage-specific prompt sentences, and integrates user state data into those prompt sentences. Such a technique should improve the technical functioning of the system by reducing noise in the input to the generative AI model, reducing unnecessary recomputation, enabling modular reuse of intermediate results, and producing more stable and relevant outputs with reduced latency and resource consumption.

The specific processing by the specific processing unit 290 of the data processing device 12 in Example 2 is realized by the following means.

The present invention provides a server comprising a processor configured to cause a terminal to acquire character information relating to a publication from a user via an input interface, perform natural language preprocessing on the character information in an information processing apparatus by executing, under control of the processor, at least morphological segmentation, removal of non-informative terms, and normalization of word forms to generate preprocessed character information, generate a first prompt sentence that instructs a generative AI model to extract one or more main themes and one or more messages of the publication by using at least the preprocessed character information, input the first prompt sentence into the generative AI model to obtain the one or more main themes and the one or more messages, generate a second prompt sentence that, based on the obtained one or more main themes and the obtained one or more messages, instructs the generative AI model to generate a summary sentence representing contents of the publication and advice information relating to goal setting and behavioral guidelines for the user, input the second prompt sentence into the generative AI model to obtain the summary sentence and the advice information, optionally acquire behavioral information and situational information of the user, including past behavioral information and past situational information, from a storage device, generate one or more additional prompt sentences that, based on the behavioral information, the situational information, and the one or more main themes and the one or more messages, instruct the generative AI model to adapt the advice information and to propose at least one goal and at least one concrete action plan corresponding to the goal, input the one or more additional prompt sentences into the generative AI model to obtain adapted advice information, the at least one goal, and the at least one concrete action plan, and cause the terminal to present at least the summary sentence and the advice information, and when generated, the adapted advice information, the at least one goal, and the at least one concrete action plan to the user via a display device. This enables an improvement in computer technology by converting raw book-related text into a structured, noise-reduced internal representation before interaction with the generative AI model, orchestrating multiple stage-specific prompt sentences that reuse intermediate AI outputs, and conditionally incorporating user state data into the prompts, thereby enhancing the efficiency, stability, and relevance of AI-assisted text analysis and recommendation while reducing computational load and response time in the server.

The term “processor” refers to one or more hardware processing units, such as a central processing unit or a graphics processing unit, and associated control logic configured to execute instructions to perform the functions described herein.

The term “terminal” refers to an electronic device including at least an input interface and a display device, such as a mobile device, a tablet device, a desktop device, or a web client, that enables a user to input information and receive presented information from a server.

The term “server” refers to an information processing apparatus including the processor, a memory, and a communication interface, configured to communicate with one or more terminals over a communication network and to execute the processing described herein.

The term “information processing apparatus” refers to a hardware system including the processor, a memory, and one or more storage devices, configured to perform computer-implemented operations such as text preprocessing, prompt generation, and communication with a generative AI model.

The term “character information” refers to digital data representing a sequence of characters or symbols, including text strings encoded in a character encoding scheme and corresponding to natural language content.

The term “publication” refers to a recorded work that includes natural language text, such as a book, a magazine, an article, or other text-based content.

The term “book information” refers to character information associated with a publication, including at least one of a title, an author name, a summary, an excerpt, or a full text of the publication.

The term “input interface” refers to a hardware or software component of the terminal that enables a user to enter data, such as a keyboard, a touch screen, a pointing device, or a graphical user interface element for text input.

The term “display device” refers to a hardware component, such as a liquid crystal display or an organic light emitting diode display, configured to visually present text, images, or graphical user interface elements to a user.

The term “natural language preprocessing” refers to a sequence of text processing operations performed by the processor on character information in order to convert the character information into a structured internal representation suitable for analysis.

The term “morphological segmentation” refers to an operation in the natural language preprocessing that divides a character sequence into smaller linguistic units, such as words, morphemes, or tokens, based on morphological or syntactic rules.

The term “removal of non-informative terms” refers to an operation in the natural language preprocessing that excludes terms having low semantic contribution, such as stop words, function words, or punctuation marks, from a set of tokens.

The term “normalization of word forms” refers to an operation in the natural language preprocessing that converts different inflected or variant forms of a word into a canonical form, such as a lemma or a stem.

The term “preprocessed character information” refers to character information that has been subjected to natural language preprocessing including at least morphological segmentation, removal of non-informative terms, and normalization of word forms.

The term “generative AI model” refers to a machine learning model trained to perform generative processing of natural language text, including generation, transformation, or analysis of text in response to an input prompt sentence.

The term “prompt sentence” refers to a text sequence, including instructions and optionally data, that is input to the generative AI model in order to specify a task to be executed by the generative AI model.

The term “first prompt sentence” refers to a prompt sentence that instructs the generative AI model to extract at least one main theme and at least one message of a publication from character information, including the preprocessed character information.

The term “second prompt sentence” refers to a prompt sentence that instructs the generative AI model to generate at least a summary sentence and advice information based on at least one main theme and at least one message previously obtained from the generative AI model.

The term “additional prompt sentence” refers to a prompt sentence, different from the first prompt sentence and the second prompt sentence, that instructs the generative AI model to adapt advice information or propose at least one goal and at least one action plan based on user-related information and previously obtained themes and messages.

The term “main theme” refers to a central topic or concept identified from character information of a publication, representing a principal subject matter treated in the publication.

The term “message” refers to a principal idea, conclusion, or intended takeaway identified from character information of a publication, representing information that the publication conveys to a reader.

The term “summary sentence” refers to one or more sentences generated by the generative AI model that concisely describe contents of a publication based on at least one main theme and at least one message.

The term “advice information” refers to text generated by the generative AI model that suggests guidelines, recommendations, or strategies for a user, including guidance related to goal setting and behavioral actions.

The term “adapted advice information” refers to advice information generated by the generative AI model that has been modified or customized based on behavioral information and situational information of a user.

The term “behavioral information” refers to data representing actions, habits, or usage patterns of a user, including at least one of interaction logs, task records, or activity histories.

The term “situational information” refers to data representing a state or context relating to a user, including at least one of temporal context, environmental conditions, device usage conditions, or user status information.

The term “past behavioral information” refers to behavioral information collected and stored for a user during a period prior to a current processing time.

The term “past situational information” refers to situational information collected and stored for a user during a period prior to a current processing time.

The term “storage device” refers to a hardware resource, such as a non-volatile memory or a magnetic disk device, configured to store behavioral information, situational information, and intermediate or final results of processing.

The term “goal” refers to a target state or objective proposed for a user to achieve, derived from themes and messages of a publication and optionally from user-related information.

The term “action plan” refers to one or more specific actions or steps that are proposed for a user to perform in order to achieve a goal.

The term “communication network” refers to a wired or wireless network, such as a local area network or a wide area network, configured to transmit data between the server and one or more terminals.

The term “user” refers to an individual or an entity that operates the terminal, provides book information, and receives the summary sentence, advice information, adapted advice information, goals, or action plans generated by the system.

In one embodiment, a server includes a processor, a memory, a non-transitory storage device, and a communication interface connected to a communication network. The server communicates with at least one terminal operated by a user. The terminal includes an input interface, a display device, a communication module, and a local memory. The user operates the terminal to provide character information relating to a publication and to view information generated by the server.

The server executes an operating system, such as a general-purpose server operating system, and an application program that implements functions described in the claims. The terminal executes a client application, such as a web browser or a native application, that presents a graphical user interface to the user and exchanges data with the server using a network protocol, such as HTTPS over TCP/IP.

The terminal presents, on the display device, one or more input fields that allow the user to enter book information as character information relating to a publication. The terminal allows the user to input at least one of a title, an author identification, a summary, a table of contents, or an excerpt of the publication. The terminal transmits the character information to the server as structured data, such as a text payload within an HTTP request.

The server stores the received character information in the storage device as book information records. In one embodiment, the server stores each record in a relational database system as a row comprising a user identifier, a publication identifier, a raw text field, and one or more metadata fields. The server indexes the raw text field to facilitate later retrieval and logging, thereby improving data management and access patterns.

The server performs natural language preprocessing on the character information. The server loads, into memory, software libraries for natural language processing, such as a tokenization module, a stop-word filtering module, and a word normalization module. The server applies morphological segmentation to the character information to obtain a sequence of tokens. The server removes non-informative terms, including stop words, punctuation, and highly frequent functional tokens, based on a pre-stored stop-word list and frequency statistics. The server normalizes word forms by converting inflected forms to canonical forms, such as lemmas or stems, using a morphological analyzer. The server stores the resulting preprocessed character information as a sequence of normalized tokens or as a compact vector representation in the storage device.

The server configures the preprocessing pipeline to reduce noise and redundancy in the character information before it is supplied to a generative AI model. By enforcing this specific sequence of morphological segmentation, removal of non-informative terms, and normalization, the server reduces the input length and the entropy of the text representation. This structured preprocessing improves computational efficiency because the generative AI model processes a shorter, more informative input. It also improves accuracy and stability, because irrelevant lexical variation is reduced and semantically central terms are emphasized in the internal representation.

The server implements a generative AI model as a trained neural network model. In one embodiment, the server uses a transformer-based neural network architecture that includes an input embedding layer, multiple self-attention layers, feed-forward layers, and an output projection layer. The server stores the model parameters, including weight matrices and bias vectors, in the storage device. The server loads the model parameters into memory at initialization time.

The server uses a training procedure in which a large corpus of natural language text is used as training data. The server applies a masked language modeling or next-token prediction objective as an error function. The server computes a loss value, such as cross-entropy loss, between predicted token probabilities and ground-truth tokens. The server updates model weights by gradient-based optimization, such as stochastic gradient descent with adaptive learning rate methods. The server may apply data augmentation techniques, such as random masking, shuffling, or sub-sampling, to improve robustness. The server thereby obtains a generative AI model that maps input text sequences, including prompt sentences and accompanying context, to output text sequences that are statistically coherent and semantically structured.

The server configures the generative AI model to operate with explicit prompt sentences that distinguish analytical stages. The server does not simply submit arbitrary book text to the model. Instead, the server generates structured prompt sentences that identify a task type, a role, an output format, and task-specific constraints. The server constructs a first prompt sentence dedicated to theme and message extraction. The server inserts, into the first prompt sentence, at least the preprocessed character information as context. For example, the server may generate a first prompt sentence such as:

“From the following text, extract the main themes and key messages of the publication.

Present the result as a bullet list with short explanations.

Text: [preprocessed book text]”

The server supplies the first prompt sentence as input tokens to the generative AI model. The server encodes the prompt sentence using a tokenizer associated with the model and processes the encoded sequence through the transformer layers. The server receives, from the output layer, a sequence of token probabilities and decodes them to character information representing one or more main themes and one or more messages of the publication. The server stores these extracted themes and messages in the storage device, linked to the publication identifier and the user identifier. By separating extraction into an explicit stage with a dedicated prompt sentence, the server enables caching and reuse of these intermediate results, thereby reducing repeated computation and improving response speed for subsequent operations.

The server generates a second prompt sentence for summary and advice generation. The server composes the second prompt sentence by referencing the stored main themes and messages. The server may generate a second prompt sentence such as:

“Based on the following main themes and key messages of a publication,
1. Generate a concise summary of the publication in 2-3 sentences.
2. Generate advice for the reader relating to goal setting and behavioral guidelines.

Main themes and key messages: [list of themes and messages]”

The server inputs the second prompt sentence to the generative AI model, receives a summary sentence and advice information, and stores them in the storage device. By decoupling this summary and advice generation from the initial extraction stage, the server avoids reprocessing the original book text. Instead, the server reuses the compact representation of themes and messages, which reduces communication load and processing time.

The server further acquires behavioral information and situational information of the user from the storage device. The server maintains a user behavior log as a data structure that records, as entries, timestamps, task identifiers, interaction patterns with the terminal, and completion status of goals. The server also maintains situational context records that include time of day, device type, network conditions, and other environmental attributes. The server may aggregate these records into feature vectors representing user state, such as average daily reading time, frequency of goal completion, or distribution of active time windows.

The server generates additional prompt sentences to adapt advice and to propose goals and action plans. In one example, the server constructs a third prompt sentence as:

“Using the following user behavior and situation, and the main themes and key messages of the publication, modify the advice so that it fits the user's current habits and environment.

User behavior and situation: [summarized behavior and context features]

Main themes and key messages: [list of themes and messages]”

The server generates a fourth prompt sentence as:

“Using the following user past behavior and past situation, and the main themes and key messages of the publication,
1. Propose at least one concrete goal that the user should achieve.
2. For each goal, propose at least one specific action plan that the user can perform daily.

User past behavior and past situation: [summarized historical features]

Main themes and key messages: [list of themes and messages]”

The server inputs these additional prompt sentences to the generative AI model, receives adapted advice information, at least one goal, and at least one action plan, and stores them in the storage device.

The server uses explicit, structured prompt sentences that encode feature vectors, aggregated statistics, and themes as text. The server can apply a deterministic ordering and formatting of features, such as listing user behavior metrics in a fixed sequence and labeling each metric with a descriptive key. This explicit structure allows the generative AI model to identify relevant attributes using learned attention patterns rather than relying on unstructured free-form descriptions. As a result, the generative AI model performs conditional generation based on well-defined attributes, improving the technical predictability and reducing variance in the outputs.

The server orchestrates these interactions with the generative AI model using a defined module structure. The server includes a preprocessing module, a prompt generation module, an AI inference module, a post-processing module, and a presentation module. The preprocessing module converts raw book text into preprocessed character information. The prompt generation module constructs first, second, and additional prompt sentences based on stored data structures. The AI inference module manages communication with the generative AI model, controls decoding parameters, and enforces token limits. The post-processing module parses generated text, detects list structures, headings, and key-value pairs by analyzing token patterns, and normalizes them into internal records in the storage device. The presentation module converts these records into display-friendly formats and transmits them to the terminal.

The server improves computational efficiency and accuracy by splitting tasks into these modules and by using preprocessed data. Because the preprocessing module removes non-informative terms and normalizes word forms, the first prompt sentence can be shorter and more focused, which reduces the number of tokens processed by the generative AI model and therefore decreases inference time and memory consumption. Because the prompt generation module creates separate prompt sentences for distinct tasks, the server can independently adjust decoding parameters, such as temperature or output length, for each task. This targeted configuration enables the generative AI model to produce more stable theme extraction outputs while allowing flexibility in advice generation, thereby optimizing technical performance.

The terminal receives, from the server, structured data representing the summary sentence, advice information, adapted advice information, goals, and action plans. The terminal converts these into a user interface presentation. The terminal may display, on separate sections of the screen, the main themes, the summary of the publication, user-specific recommendations, and concrete action steps. The terminal may provide interactive elements that allow the user to select a goal, mark an action as completed, or request re-generation of advice. Based on user interactions, the terminal transmits new behavioral information back to the server, allowing the server to update behavior logs and refine future prompt sentences.

The server thereby forms a closed-loop system in which book information and user behavior information are processed in an integrated way. The server does not merely automate human reading or summarization; instead, the server implements a specific technical architecture that reduces noise, structures internal representations, decomposes generative tasks, and reuses intermediate outputs. This architecture results in reduced token counts supplied to the generative AI model, lower latency in generating results, improved repeatability of thematic extraction, and more efficient use of communication bandwidth between the server and an external AI processing resource when such a resource is used.

In an alternative embodiment, the server executes the generative AI model locally on dedicated hardware, such as an accelerator device. The server may use a neural network engine that performs matrix multiplications in parallel using vectorized instructions or specialized processing units. The server benefits from hardware acceleration for inference, further reducing processing time and enabling real-time interaction with the user through the terminal.

In another embodiment, the server varies the configuration of the generative AI model based on the length and complexity of the book information. For shorter texts, the server may employ a smaller model variant with fewer layers and reduced parameter count, while for longer texts, the server may use a larger model variant to capture more complex patterns. The server can dynamically select the model variant and associated prompt templates, thereby optimizing resource usage and maintaining accuracy across diverse input sizes.

In another embodiment, the server modifies the natural language preprocessing pipeline. For certain languages or domains, the server may add named-entity recognition or phrase chunking to the preprocessing step. The server then embeds named entities and key phrases directly into prompt sentences as labeled segments, which can guide the generative AI model to focus on central concepts. This structured guidance contributes to a reduction in hallucinated or irrelevant output and increases precision in the extracted themes and recommended goals.

In yet another embodiment, the server maintains a cache of previously extracted themes and messages for popular publications. When a new user submits book information that matches or closely resembles a stored publication, the server retrieves cached themes and messages instead of re-invoking the generative AI model for extraction. The server then generates subsequent prompt sentences for summary, advice, and goal generation based on the cached data. This caching strategy reduces computation, accelerates responses, and decreases network traffic when the generative AI model is deployed as a remote service.

The described embodiments illustrate how the server, the terminal, and the user cooperate in a configuration that improves computer technology. The server structures and preprocesses text data, uses a transformer-based generative AI model under explicit, stage-specific prompt control, and integrates user behavior and situational features into prompt sentences. Through these measures, the system achieves technical effects including improved processing speed, reduced communication overhead, enhanced stability and accuracy of generated outputs, and efficient reuse of intermediate computational results.

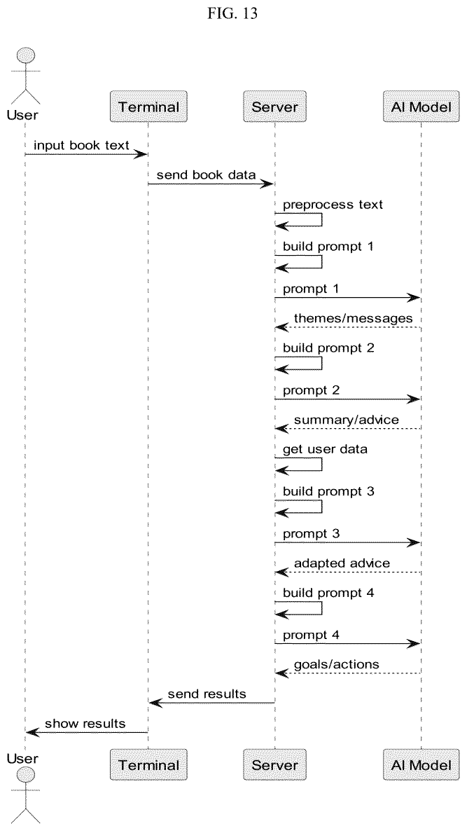

The following describes the processing flow using FIG. 13.

### Step 1

The user operates the terminal to input book information.

The terminal displays an input screen including text fields for a title, an optional summary, and an optional excerpt.

The user enters character information relating to a publication, such as a title string and one or more paragraphs of text.

The terminal validates that required fields are not empty and converts the input into an internal data structure.

Input: raw character data entered by the user (for example, “Title: The 7 Habits of Highly Effective People. Text: This book describes seven core habits that improve personal effectiveness . . . ”).

Output: a structured book information object held in the terminal's memory (for example, a set of labeled text fields).

### Step 2

The terminal transmits the structured book information to the server.

The terminal serializes the book information object into a text payload and attaches it to a network request addressed to the server.

The terminal sends the request over a communication network and waits for a response.

Input: the structured book information object in the terminal's memory.

Output: a corresponding request message delivered to the server containing the character information for the publication.

### Step 3

The server receives and stores the raw book information.

The server parses the incoming request message, extracts the title, summary, and excerpt fields, and stores them in a storage device as a book record associated with a user identifier.

The server logs metadata such as reception time and input length for later analysis.

Input: a network request containing character information (title, summary, excerpt).

Output: a stored book record and a raw text string composed from the received character information, ready for preprocessing.

### Step 4

The server performs natural language preprocessing on the character information.

The server applies morphological segmentation to split the raw text string into tokens, removes non-informative terms using a stop-word list and punctuation filters, and normalizes word forms to canonical lemmas or stems.

The server optionally converts the resulting tokens into a compact representation, such as a space-separated normalized text string or a token list.

Input: the raw text string representing the book information from the stored book record.

Output: preprocessed character information in the form of a normalized token sequence or normalized text string.

### Step 5

The server generates a first prompt sentence for theme and message extraction.

The server constructs an instruction section that specifies a task type and an output format, and then inserts at least the preprocessed character information as a context section.

The server concatenates the instruction section and the context section into a single text string as a first prompt sentence, for example:

“From the following text, extract the main themes and key messages of the publication.

Present the result as a bullet list with short explanations.

Text: [preprocessed book text]”

Input: the preprocessed character information and a prompt template stored in the server.

Output: a first prompt sentence formatted as a continuous text sequence.

### Step 6

The server invokes the generative AI model using the first prompt sentence.

The server encodes the first prompt sentence into tokens according to the tokenizer associated with the generative AI model and supplies the encoded sequence to the model's inference engine.

The server receives a generated output sequence, decodes the sequence back into a text string, and interprets the string as one or more main themes and one or more messages of the publication.

Input: the first prompt sentence as a text string.

Output: an extracted themes-and-messages text string, representing a list of main themes and key messages.

### Step 7

The server stores the extracted themes and messages as intermediate data.

The server writes the themes-and-messages text string to the storage device and associates it with the corresponding book record and user identifier.

The server may convert the text into an internal structure, such as a list of theme entries and message entries, for later use.

Input: the extracted themes-and-messages text string produced by the generative AI model.

Output: a persistent intermediate representation of themes and messages linked to the book record.

### Step 8

The server generates a second prompt sentence for summary and generic advice generation.

The server retrieves the intermediate themes and messages from the storage device and inserts them into a summary-and-advice prompt template.

The server constructs a second prompt sentence, for example:

“Based on the following main themes and key messages of a publication,
1. Generate a concise summary of the publication in 2-3 sentences.
2. Generate advice for the reader relating to goal setting and behavioral guidelines.

Main themes and key messages: [list of themes and messages]”

Input: the stored themes-and-messages representation and a second prompt template.

Output: a second prompt sentence specifying summary and advice generation.

### Step 9

The server invokes the generative AI model using the second prompt sentence.

The server encodes the second prompt sentence into tokens, processes the tokens through the generative AI model, and decodes the generated output tokens into text.

The server parses the output text to separate a summary section and an advice section based on line breaks, headings, or list markers.

Input: the second prompt sentence as a text string.

Output: a summary sentence (or sentences) describing the publication and advice information relating to goal setting and behavioral guidelines.

### Step 10

The server optionally acquires behavioral information and situational information of the user.

The server retrieves, from the storage device, records of user behavior such as past interactions, goal completion statuses, and time-of-day usage patterns, as well as situational information such as device type and typical session duration.

The server aggregates these records into compact descriptors, such as averages, counts, or categorical labels.

Input: existing behavior logs and situational records stored for the user.

Output: aggregated behavioral information and situational information in a structured internal format.

### Step 11

The server generates an additional prompt sentence to adapt advice according to current user state.

The server inserts the aggregated behavioral and situational descriptors, together with the extracted themes and messages, into an adaptation prompt template.

The server constructs an additional prompt sentence, for example:

“Using the following user behavior and situation, and the main themes and key messages of the publication,

modify the advice so that it fits the user's current habits and environment.

User behavior and situation: [summarized behavior and context features]

Main themes and key messages: [list of themes and messages]”

Input: the aggregated behavioral information, situational information, and themes-and-messages representation.

Output: an adaptation prompt sentence instructing the generative AI model to produce adapted advice.

### Step 12

The server invokes the generative AI model using the adaptation prompt sentence.

The server encodes the adaptation prompt sentence, processes it through the generative AI model, and decodes the generated output into text.

The server interprets the output as adapted advice information that takes into account the user's behavior and situation.

Input: the adaptation prompt sentence as a text string.

Output: adapted advice information tailored to the behavioral and situational information of the user.

### Step 13

The server generates a further prompt sentence to propose goals and action plans based on past user history.

The server retrieves past behavioral information and past situational information from the storage device and summarizes these into descriptive features.

The server constructs a further prompt sentence, for example:

“Using the following user past behavior and past situation, and the main themes and key messages of the publication,
1. Propose at least one concrete goal that the user should achieve.
2. For each goal, propose at least one specific action plan that the user can perform daily.

User past behavior and past situation: [summarized historical features]

Main themes and key messages: [list of themes and messages]”

Input: summarized past behavioral information, summarized past situational information, and the stored themes-and-messages representation.

Output: a goal-and-action prompt sentence instructing the generative AI model to propose goals and action plans.

### Step 14

The server invokes the generative AI model using the goal-and-action prompt sentence.

The server encodes the goal-and-action prompt sentence, processes it in the generative AI model, and decodes the output tokens to obtain text representing at least one goal and at least one concrete action plan.

The server parses the text to identify goal descriptions and associated action items, storing them as structured goal-and-action records in the storage device.

Input: the goal-and-action prompt sentence as a text string.

Output: one or more goal descriptions and corresponding action plans formatted as structured records.

### Step 15

The server aggregates the generated information into a response package.

The server collects the summary sentence, the original advice information, the adapted advice information (if generated), and the goal-and-action records.

The server converts these elements into a structured response format suitable for presentation, assigning section identifiers such as “Themes,” “Summary,” “Advice,” “Adapted Advice,” and “Goals and Actions.”

Input: the generated summary, advice information, adapted advice, and goal-and-action records stored in internal data structures.

Output: a consolidated response package representing all generated content in a form ready for delivery to the terminal.

### Step 16

The server transmits the response package to the terminal.

The server serializes the response package into a text-based format, attaches it to a network response message, and sends the message over the communication network to the terminal.

The server may log the size and transmission time of the response for monitoring and optimization.

Input: the consolidated response package in the server's memory.

Output: a response message delivered to the terminal containing the summary, advice, adapted advice, and goal-and-action information.

### Step 17

The terminal receives and presents the generated information to the user.

The terminal parses the received response message and extracts each section of the generated content.

The terminal renders the themes, summary, advice, adapted advice, and goals with action plans in separate display regions or panels on the display device.

The terminal may allow the user to scroll, tap, or select individual goals for tracking or further interaction.

Input: the response message received from the server containing the generated content.

Output: a visual presentation of the extracted themes, summary sentences, advice information, adapted advice information, and proposed goals and action plans on the terminal's display for the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented recommendation and coaching systems, the processor typically treats user inputs such as book titles, free-form comments, and goals as isolated and static data. The systems often (i) apply simple keyword matching or rule-based logic, (ii) invoke a generative AI model with generic prompt sentences that are not systematically constructed from the full context of the user, and (iii) display generated text without feeding back user reactions into the underlying computational pipeline. As a result, the generated summaries, advice, and recommendations are frequently generic, weakly personalized, and inconsistent across different sessions.

Furthermore, many existing systems process book content, user goals, user emotional state, and usage history in separate subsystems. A typical processor may first extract topics from a book, in a separate process estimate user sentiment, and in yet another process log user history, without maintaining a unified context data structure that explicitly combines these heterogeneous data items. When such fragmented data is provided to a generative AI model, the prompt sentence cannot systematically reflect all relevant factors, limiting the ability of the model to generate high-quality, user-tailored output. This fragmentation leads to inefficient use of computing resources, because the generative AI model is repeatedly invoked with incomplete or redundant information, increasing network calls and processing load without corresponding improvements in output quality.

Additionally, known systems generally do not treat the generation of prompt sentences itself as a first-class computational function in the processor. Prompt construction is often hard-coded or manually defined, ignoring dynamic elements such as changes in emotion state, recent user selections, or cross-domain history (for example, viewing history and purchase history). This prevents the system from adapting the instruction content and expression style of prompt sentences in real time, which degrades both the responsiveness and the effectiveness of the overall computer system.

In the field of audiovisual and financial guidance, existing computer systems also lack a coordinated mechanism for integrating generative AI outputs with conventional search and analysis modules. For example, content recommendation modules may operate independently of generative AI modules, and financial advice modules may not incorporate emotional analysis or reading context. This separation leads to duplicated data access and inconsistent decision logic across components, thereby increasing latency, complicating maintenance, and reducing the overall reliability of the system as a computing platform.

Accordingly, there is a need for an improved computer system in which the processor (i) acquires and integrates heterogeneous user-related information, including written work information, goal information, emotion state information, and history information, into structured context information, (ii) systematically generates prompt sentences based on the context information for a generative AI model, (iii) coordinates the generative AI model with other computational modules such as audiovisual search and financial analysis, and (iv) feeds back user selection and evaluation information into the context information. By improving how the processor structures, uses, and updates this context and how it constructs and applies prompt sentences, the present invention aims to improve the functioning of the computer system itself, in terms of personalization accuracy, resource utilization, responsiveness, and consistency of generated outputs.

The specific processing by the specific processing unit 290 of the data processing device 12 in Application Example 2 is realized by the following means.

The present invention provides a server comprising a processor and a storage device, the processor being configured to execute computer-implemented operations including: acquiring, via an information input interface, information regarding a written work read or to be read by a user and information regarding a goal of the user, and storing the acquired information in the storage device; performing natural language processing on character string data included in the information regarding the written work to extract subject information and message information of the written work and storing the extracted subject information and message information in the storage device; acquiring emotion-related information from the user, estimating emotion state information of the user on the basis of the emotion-related information and the information regarding the written work, and storing the emotion state information in the storage device; generating context information including at least the subject information of the written work, the message information of the written work, the information regarding the goal of the user, and the emotion state information of the user; generating, on the basis of the context information, a prompt sentence that instructs execution of at least one process among a summary generation process, an advice generation process, a recommendation generation process, and a financial guidance generation process; inputting the prompt sentence into a generative AI model provided by an external computing device, causing the generative AI model to execute text generation processing, and acquiring, as generated result data, at least one kind of information among summary information of the written work, advice information for the user, recommendation information of content, and financial behavior guidance information; executing a search process on an information storage device that stores audiovisual content, on the basis of at least the subject information of the written work and the emotion state information of the user, and acquiring recommendation information of related audiovisual content; and presenting, via a display device, at least one of the generated result data and the recommendation information of the audiovisual content to the user, acquiring selection information or evaluation information from the user, and updating the context information stored in the storage device on the basis of the selection information or the evaluation information. This enables the computer system to internally construct and maintain a unified, dynamically updated context for each user, to generate task-specific prompt sentences that fully reflect that context, to coordinate external generative AI processing with local search and analysis modules, and to iteratively refine subsequent processing on the basis of user feedback, thereby improving personalization accuracy, computational efficiency, and consistency of outputs in comparison with conventional systems.

The term “user” refers to a human individual who operates a client device, inputs information such as written work information, goal information, and emotion-related information, and receives generated information such as summaries, advice, recommendations, or guidance through a display device.

The term “written work” refers to any information medium that contains textual content, including but not limited to books, articles, documents, or other narrative or expository texts, which is read or intended to be read by the user and is processed as character string data by the system.

The term “information input interface” refers to a hardware and software combination that enables the user to provide data to the system, including graphical user interfaces, form fields, touch screens, keyboards, microphones, and network communication modules that transmit the provided data to the processor.

The term “goal information” refers to data representing an objective or target state specified by the user, such as behavioral goals, learning goals, financial goals, or other desired outcomes, which is stored by the system and used to generate context information and prompt sentences.

The term “storage device” refers to any computer-readable recording medium or memory subsystem, including volatile memory and non-volatile memory, configured to store program code, user data, context information, and intermediate or final processing results used by the processor.

The term “natural language processing” refers to a class of computational techniques by which the processor analyzes, interprets, and manipulates human language text, including operations such as tokenization, part-of-speech tagging, parsing, semantic analysis, keyword extraction, and topic extraction.

The term “subject information” refers to data representing one or more main topics, themes, or conceptual categories of a written work, extracted from character string data of the written work by the processor using natural language processing.

The term “message information” refers to data representing one or more principal messages, intentions, or key ideas conveyed by a written work, obtained by the processor through semantic analysis of the written work and stored as structured information.

The term “emotion-related information” refers to data that reflects the user's emotional state or affect, including text expressing feelings, audio signals of speech, or other signals from which an emotional condition of the user can be inferred.

The term “emotion state information” refers to structured data representing an estimated emotional condition of the user, such as sentiment values or emotion category labels, computed by the processor on the basis of emotion-related information and optionally written work information.

The term “context information” refers to a structured aggregation of multiple types of data associated with the user, including at least subject information, message information, goal information, and emotion state information, and optionally history information and feedback information, maintained for use in generating prompt sentences and controlling processing.

The term “prompt sentence” refers to a natural language text string generated by the processor that encodes an instruction to a generative AI model, specifying at least a processing task to be performed and a context to be considered, so as to cause the generative AI model to generate corresponding output text.

The term “generative AI model” refers to a machine-implemented model, such as a neural network-based language model, that receives a prompt sentence as input and generates text data as output, including summaries, advice, recommendations, or guidance, based on learned statistical relationships in training data.

The term “external computing device” refers to a processing system distinct from the server on which the processor resides, the external computing device hosting or providing access to the generative AI model and executing text generation processing in response to prompt sentences transmitted from the processor.

The term “generated result data” refers to text information output by the generative AI model in response to a prompt sentence, including at least one among summary information of a written work, advice information for the user, recommendation information of content, and financial behavior guidance information.

The term “summary information” refers to generated result data that concisely represents key themes, messages, or contents of a written work, in a more compact textual form than the original written work.

The term “advice information” refers to generated result data that provides suggestions, instructions, or coaching to the user, taking account of at least the user's written work information, goal information, and emotion state information.

The term “recommendation information of content” refers to generated result data or search result data that identifies one or more content items, such as audiovisual works or written works, proposed for the user based on context information.

The term “financial behavior guidance information” refers to generated result data that provides suggestions or guidance concerning financial behavior of the user, including saving, spending, or investment actions, derived from prompt sentences and context information.

The term “information storage device that stores audiovisual content” refers to a storage subsystem or database, which may be local or remote, that maintains records associated with audiovisual content items such as videos, motion pictures, or audio programs, including metadata used for search and recommendation.

The term “audiovisual content” refers to media content having at least one visual component and at least one audio component, including but not limited to films, series, documentaries, or recorded programs, that can be recommended and presented to the user.

The term “recommendation information of related audiovisual content” refers to data specifying one or more audiovisual content items selected by the processor as being related to at least subject information of a written work and emotion state information of the user, and including identifiers or metadata enabling presentation to the user.

The term “display device” refers to any output apparatus configured to visually present information to the user, including but not limited to a monitor, a touch screen, or a graphical display of a client terminal.

The term “selection information” refers to data representing a choice made by the user among one or more items presented by the system, such as selection of a recommended content item or acceptance of advice.

The term “evaluation information” refers to data representing a reaction or assessment by the user regarding presented information, such as ratings, feedback tags, or other indications of usefulness or preference.

The term “history information” refers to data accumulated over time concerning user interactions, including at least one of reading history information, viewing history information, purchase history information, and past emotion state information, stored in association with the user.

The term “reading history information” refers to a subset of history information that records past written works that the user has read or interacted with, and optionally associated timestamps, progress data, and feedback.

The term “viewing history information” refers to a subset of history information that records audiovisual content viewed or accessed by the user, and optionally associated timestamps and viewing details.

The term “purchase history information” refers to a subset of history information that records purchase or transaction activities of the user, including at least item identifiers, amounts, and timestamps, used by the processor for financial guidance processing.

The term “history information storage device” refers to a storage device or database specifically configured to store and provide access to history information associated with one or more users.

The term “goal proposal” refers to generated result data that proposes a new or modified objective for the user, derived from context information and history information and designed to support the user's development or improvement.

The term “action plan proposal” refers to generated result data that specifies a sequence of actions or steps for the user to perform in order to achieve a goal, constructed based on context information and history information.

The term “saving guidance proposal” refers to a type of financial behavior guidance information that suggests ways for the user to reduce expenditures, increase savings, or otherwise improve financial conservatism.

The term “investment guidance proposal” refers to a type of financial behavior guidance information that suggests strategies or considerations for allocating resources toward investment activities, taking into account at least purchase history information and emotion state information of the user.

The term “server” refers to an information processing apparatus comprising at least one processor and at least one storage device, configured to communicate with one or more client devices over a network and to perform the operations described in connection with the present invention.

The term “processor” refers to one or more processing circuits or computing units, such as a central processing unit or a microcontroller, capable of executing program instructions to perform the acquisition, analysis, context generation, prompt generation, model interaction, search, and presentation operations described herein.

In one embodiment, a server cooperates with at least one terminal operated by a user to implement the claimed system. The server includes at least one processor, a main memory, a non-volatile storage device, and a network interface. The terminal includes at least one processor, a memory, a display device, an audio input device, a character input device, and a communication module such as a wireless transceiver. The server and the terminal communicate via a network such as the Internet using a protocol such as HTTP over TLS.

The server executes an operating system such as a general-purpose server operating system and application software implemented, for example, using a programming language such as a scripting language. The server software includes modules for natural language processing, emotion estimation, context management, prompt sentence generation, generative AI model interaction, audiovisual content search, financial analysis, and user interface response generation. The server uses libraries such as a natural language toolkit library, a transformer-based language processing library, and client libraries for external sentiment analysis and generative AI services. The terminal executes an application that provides an information input interface, displays generated information, and forwards user inputs to the server.

The terminal presents to the user graphical input components such as text boxes, selection lists, and buttons on the display device. The user operates the terminal to input information regarding a written work, including at least a title and optionally an author, a summary, impressions, or comments. The user further inputs goal information such as “read 30 minutes every day” or “reduce entertainment spending,” and optionally emotion-related information such as “I feel stressed and overwhelmed lately.” The terminal converts these inputs into character string data and associates them with a user identifier stored in the terminal memory. The terminal transmits the character string data to the server through the communication module.

The server stores the received data in records within the storage device using structured data formats. The server maintains a user table, a written work table, a goal table, a history table, and a context table. Each context record stores, in association with a user identifier, subject information fields, message information fields, goal information fields, emotion state information fields, and optional feedback fields. Subject information fields store vectors of topic identifiers extracted from written work text, message information fields store higher-level conceptual descriptors derived from semantic analysis, and emotion state information fields store discrete emotion labels and continuous sentiment scores.

The server performs natural language processing on the character string data related to the written work. In one embodiment, the server uses a tokenizer to convert the text into token sequences, applies part-of-speech tagging to assign syntactic roles, and applies a transformer-based encoder model to obtain contextual embeddings for each token. The server computes weighted averages of token embeddings and applies a clustering or classification layer to map the embeddings to a fixed set of subject categories. For example, the server maps a written work titled “The 7 Habits of Highly Effective People” to subject categories corresponding to “time management,” “prioritization,” and “proactivity.” The server stores the resulting subject information as categorical identifiers and also stores message information as short text labels such as “personal responsibility” or “habit formation,” which the server derives from the attention patterns and classification outputs of the transformer encoder.

The server estimates emotion state information based on emotion-related information and optionally written work information. In one embodiment, the server transmits user text such as “I feel stressed and overwhelmed lately” to an external sentiment analysis service via the network interface. The server receives from the external service a response containing scores and labels such as negative sentiment and “stressed.” The server normalizes the scores, maps them to internal labels, and stores the resulting emotion state information in the context table. In another embodiment, the server processes audio data received from the terminal by applying an acoustic feature extractor to obtain features such as pitch, energy, and spectral coefficients, and then applies a neural classifier trained on emotion-labeled speech to determine an emotion label. By using both text and audio channels and combining their scores using a weighting function, the server improves robustness and precision of emotion estimation compared to relying on a single channel.

The server constructs context information as a multi-field data structure linking subject information, message information, goal information, and emotion state information. The server uses this context information as a basis for generating a prompt sentence for a generative AI model. The server maintains template definitions in the storage device, where each template specifies a prompt structure such as task type, context fields to reference, output constraints, and stylistic constraints. The server selects a template according to the task type (for example, summary generation, advice generation, recommendation generation, or financial guidance generation) and fills placeholders with corresponding context field values.

For example, when the user reads “The 7 Habits of Highly Effective People,” sets the goal “read 30 minutes every day,” and has an emotion state “stressed,” the server generates a prompt sentence such as:

“The user is reading ‘The 7 Habits of Highly Effective People’ (themes: time management, prioritization, proactivity). The user's goal is to read 30 minutes every day. Emotional state: stressed. Provide three concrete steps to reorganize daily tasks so the user can secure 30 minutes of reading while reducing stress.”

In another example, when the user is reading a fantasy novel such as “Harry Potter” and the emotion state is positive and moved, the server generates a prompt sentence such as:

“The user felt deeply moved by the fantasy novel ‘Harry Potter’. Recommend three fantasy movies with similar emotional impact, and briefly justify each recommendation.”

In a further example, when the server accesses purchase history records indicating high entertainment spending and low savings, and the emotion state indicates a low mood, the server generates a prompt sentence such as:

“The user's recent spending shows high entertainment expenses and low savings. The user feels down and may be engaging in emotional spending. Provide three empathetic, concrete strategies to reduce unnecessary spending and improve savings.”

The server transmits the generated prompt sentence to a generative AI model hosted on an external computing device. In one embodiment, the generative AI model is a transformer-based language model that comprises multiple layers of self-attention and feed-forward networks. The model uses learned weight matrices to compute attention scores between tokens and to produce output token distributions. The model has been trained in advance on large corpora using an autoregressive language modeling objective, in which the training algorithm minimizes a cross-entropy loss between predicted token probabilities and ground truth next tokens. During training, the model uses gradient-based optimization (for example, stochastic gradient descent or a variant thereof) and updates weights by backpropagating errors through the attention and feed-forward layers.

The server encodes the prompt sentence as a sequence of tokens, normalizes it using the same vocabulary and tokenization scheme as the generative AI model, and transmits the token sequence and inference parameters (such as maximum output length and temperature) via an application programming interface exposed by the external computing device. The external computing device executes the forward-pass computations of the model, including matrix multiplications for attention, softmax operations to compute attention weights, and non-linear transformations in the feed-forward layers. The external computing device returns generated text tokens to the server, which decodes them into character strings and aggregates them as generated result data.

The server may adapt the prompt sentence in a way that directly improves computational efficiency and output quality. For instance, the server limits prompt length by including only high-relevance context fields determined by a relevance scoring function that combines subject similarity scores, goal alignment scores, and emotion relevance scores. By discarding low-relevance context tokens, the server reduces the number of tokens processed by the generative AI model, thereby reducing inference time and network bandwidth while retaining critical information needed for accurate generation. This selective context inclusion is not a mere human-equivalent manual summarization but an algorithmic optimization that operates on structured context fields and token importance scores, providing a technical improvement in the operation of the model and the networked system.

The server coordinates generative AI processing with audiovisual content search. The server queries an audiovisual content storage device or service by composing a search request that includes subject information and emotion state information. The server may convert subject information into standardized tags and use them as search constraints, and may adjust ranking weights based on the user's current emotion state. For example, when subject information includes “magic” and “friendship” and emotion state is positive, the server assigns higher scores to fantasy content with positive emotional arcs. The server merges search results with generative AI outputs to form recommendation information. This coordination ensures that the recommendation logic is not purely rule-based but is guided by continuously updated context information, improving precision and user relevance.

The terminal receives generated result data and recommendation information from the server and displays them on the display device in separate sections such as “Summary,” “Advice,” “Related Audiovisual Content,” and “Financial Guidance.” The user may select items, mark items as useful, or rate them. The terminal transmits selection information and evaluation information to the server. The server updates the context table and the history table to reflect these interactions, thereby creating a feedback loop.

The server uses history information, including reading history, viewing history, purchase history, and past emotion state information, to refine subsequent processing. For example, when the history table indicates that the user consistently saves advice related to time management and often selects documentary content about productivity, the server updates internal preference scores for certain subject categories. Those scores influence future prompt sentence construction by adjusting which context fields are emphasized or de-emphasized. The server may modify prompt sentences to request more detailed guidance on favored subjects, leading to more targeted generative AI outputs without requiring manual adjustment by the user.

The server thereby improves the functioning of the computer system in several technical respects. First, by generating prompt sentences from structured context information instead of passing raw, unorganized user text to the generative AI model, the server reduces redundancy and avoids irrelevant tokens in the prompt. This reduction directly decreases the computational burden on the model, leading to faster response times and lower resource consumption. Second, by algorithmically selecting and weighting context fields based on subject information, goal information, emotion state information, and history information, the server increases the likelihood that the generative AI model will produce highly relevant outputs, which is reflected in reduced post-processing and shorter user interaction cycles. Third, by storing and updating context information and history information in a normalized data structure, the server enables incremental updates and avoids re-processing entire user histories, which results in improved data management and more efficient database accesses.

The server processes emotion-related information and history information using rule sets and model-based decision logic that differ from conventional manual operations. For example, the server may define non-linear mapping functions that convert sentiment scores and purchase frequency metrics into risk levels for emotional overspending. These risk levels are then encoded into prompt sentences in a structured manner. A human operator would not typically apply such algorithmic weighting and encoding at the speed and scale achieved by the server, and such operations are specifically optimized to interface with a generative AI model.

In another embodiment, the server uses a neural network specifically trained to predict content suitability scores given subject information, emotion state information, and history features. The network may be a feed-forward network or a shallow transformer that takes as input numerical feature vectors derived from the context table. The server trains this network using a loss function that penalizes mismatches between predicted suitability scores and historical user selections. By integrating this network's outputs into the ranking of both audiovisual content search results and generative AI recommendations, the server achieves lower prediction error rates and more stable rankings over time. This integration illustrates that the system is not merely automating human decision-making but is employing specialized machine learning components to optimize internal data flows and ranking mechanisms.

In a further embodiment, the server uses different templates and prompt construction rules for different device capabilities of terminals. For example, when the terminal has limited display resolution or bandwidth, the server constructs prompt sentences that instruct the generative AI model to produce shorter, more compact responses, thereby reducing data volume transmitted back to the terminal. This adaptive prompt generation reduces communication load and improves responsiveness on resource-constrained devices, providing a technical advantage in networked environments.

The system can be implemented in alternative configurations. In one alternative, some natural language processing functions are executed on the terminal, such as initial tokenization and basic sentiment detection, and the terminal transmits partially processed features instead of raw text. In another alternative, the generative AI model is deployed locally on the server rather than on an external computing device, and the server directly executes the forward-pass computations. In yet another alternative, the audiovisual content storage device is integrated into the server storage device rather than being a remote service. In each configuration, the core concept of constructing structured context information, generating prompt sentences based on that context, and using generative AI outputs in conjunction with search and analysis modules remains the same.

The server integrates these components and operations into a coherent architecture that improves the overall computer system beyond a simple automation of human reading and advising tasks. By explicitly managing context information, optimizing prompt sentence construction for a generative AI model, coordinating external model inference with local search and ranking algorithms, and incorporating feedback loops based on user selections and evaluations, the server enhances processing speed, output precision, and resource efficiency in a way that is closely tied to the technical operation of the computing devices, memories, and communication interfaces involved.

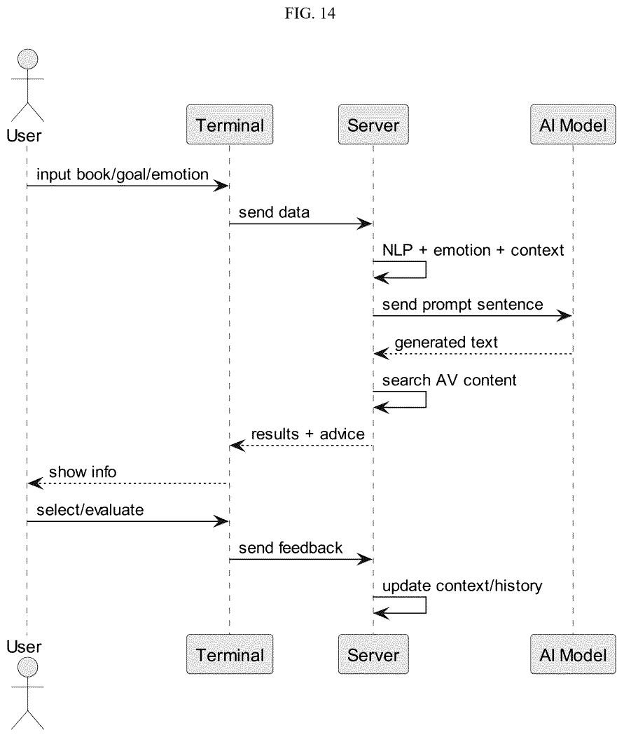

The following describes the processing flow using FIG. 14.

### Step 1

User operates the terminal to input written work information, goal information, and emotion-related information.

User enters, via a graphical input interface on the terminal, at least a title of a written work, optionally an author, a summary, impressions, a goal such as “read 30 minutes every day,” and emotion-related text such as “I feel stressed and overwhelmed.”

Input: raw keystrokes and touch events from the user.

Terminal converts the keystrokes and touch events into character string data, associates the data with a user identifier stored in terminal memory, and performs basic validation (for example, checking that the title field is not empty).

Output: structured input data objects containing fields such as written work text, goal text, and emotion-related text.

### Step 2

Terminal transmits structured input data to the server over a network.

Terminal packages the written work information, goal information, and emotion-related information into a request message (for example, JSON) and attaches a user identifier and timestamps.

Input: structured input data objects stored in terminal memory.

Terminal performs data serialization, opens a secure network connection using a communication module, and sends the serialized data to a predefined server endpoint using a network protocol.

Output: network packets carrying the structured input data to the server.

### Step 3

Server receives the request and stores the raw input data in storage.

Server listens on a network interface, accepts the incoming request, and parses the request body into internal data structures.

Input: network packets containing serialized input data.

Server validates field types and required fields, assigns internal identifiers (for example, written work ID, goal ID, context ID), and writes the data into relational tables or document collections in a storage device.

Output: persistent records in a database for written work information, goal information, emotion-related information, and an initial context record linked by identifiers.

### Step 4

Server performs natural language processing on the written work information to extract subject information and message information.

Server retrieves from storage the character string data representing the written work title, summary, and impressions, and feeds this data into a natural language processing pipeline implemented with a language processing library.

Input: text fields of the written work record (for example, title string, summary string).

Server tokenizes the text, applies part-of-speech tagging, generates contextual embeddings using a transformer encoder, and applies a classifier or clustering algorithm to map the embeddings to subject categories and key messages. The server then normalizes the categories into a fixed internal representation (for example, category identifiers and short labels).

Output: subject information (for example, a list of category identifiers such as “time management,” “proactivity”) and message information (for example, key idea labels such as “habit formation”), which the server stores in the context record.

### Step 5

Server estimates emotion state information from emotion-related information.

Server retrieves emotion-related text and optionally audio references from storage and passes them to an emotion analysis module.

Input: emotion-related text such as “I feel stressed and overwhelmed” and, optionally, audio feature references.

Server either calls an external sentiment analysis service or executes a local emotion classification model. The server converts text to tokens or extracts acoustic features, feeds them into a sentiment or emotion classifier, and receives scores or labels (for example, negative sentiment, “stressed”). The server maps these scores and labels to internal emotion categories and continuous values.

Output: emotion state information (for example, label “stressed” and sentiment score) stored in the context record.

### Step 6

Server acquires and aggregates history information related to the user.

Server queries history tables for past interactions, including reading history, viewing history, purchase history, and past emotion state records associated with the user identifier.

Input: user identifier and database records in history tables.

Server executes database queries, loads matching records, and transforms them into feature vectors or structured lists (for example, counts of certain subject categories, average sentiment over time, frequency of certain content types).

Output: history feature data integrated into the context record as additional context fields.

### Step 7

Server constructs context information for the current session.

Server combines subject information, message information, goal information, emotion state information, and history feature data into a single structured context object.

Input: subject information, message information, goal text, emotion state information, and history feature data retrieved from storage.

Server normalizes each component (for example, converts lists to fixed-length vectors, encodes categorical labels as identifiers), merges them into a unified structure, and stores this structure in a context table indexed by user identifier and session identifier.

Output: context information representing a comprehensive, machine-readable description of the user state and written work state.

### Step 8

Server selects a task type and a prompt template based on the context.

Server determines whether the current processing requires summary generation, advice generation, recommendation generation, financial guidance, or a combination, using rules or configuration associated with the application state.

Input: context information fields (for example, presence of a financial goal, presence of a viewing preference, current emotion state).

Server evaluates rule conditions (for example, “if goal includes financial terms and purchase history is available, include financial guidance process”) and selects an appropriate prompt template that defines the structure and required fields for the prompt sentence.

Output: selection of a task type and a prompt template specification referencing context fields.

### Step 9

Server generates a prompt sentence tailored to the context.

Server reads the selected prompt template and replaces placeholders with concrete values from the context information.

Input: prompt template and context information object.

Server inserts written work title, subject labels, goal text, and emotion labels into the template and may also include concise history summaries (for example, “recent high entertainment spending and low savings”). The server may truncate or rephrase fields to satisfy maximum length constraints. The server thereby produces a full prompt sentence.

Output: a prompt sentence string ready to be provided to a generative AI model.

### Step 10

Server transmits the prompt sentence to a generative AI model and requests generation.

Server encodes the prompt sentence into tokens compatible with the generative AI model's vocabulary and sends an inference request to an external computing device hosting the model.

Input: prompt sentence string and model parameters (for example, maximum token length, temperature).

Server performs tokenization, builds a model input structure, and transmits it via an application programming interface. The external model executes neural network computations and returns generated token sequences, which the server decodes into text.

Output: generated text data (for example, summary text, advice text, recommendation text) stored as generated result data.

### Step 11

Server post-processes the generated result data and categorizes it.

Server analyzes the generated text to identify sections corresponding to summary information, advice information, recommendation information, or financial behavior guidance information.

Input: raw generated text from the generative AI model.

Server applies pattern detection, simple markup parsing, or natural language segmentation to split the output into logical units, labels each unit with a type (for example, “advice bullet,” “summary paragraph”), and filters out irrelevant or redundant fragments.

Output: structured generated result data categorized by type and linked to the context record.

### Step 12

Server searches audiovisual content based on subject information and emotion state information.

Server constructs a search query using the subject information (for example, “magic,” “friendship”) and emotion state information (for example, positive, stressed) as filters and ranking factors.

Input: subject information and emotion state information from the context record.

Server generates query parameters or SQL statements, sends them to an audiovisual content storage device or content service, and receives a list of matching content items with metadata. The server computes relevance scores that combine tag matching and emotion suitability and ranks the items accordingly.

Output: recommendation information of related audiovisual content stored as a ranked list associated with the context record.

### Step 13

Server composes a response payload including generated result data and recommendation information.

Server prepares a response structure that groups summary information, advice information, recommendation information of content, and financial guidance information for transmission to the terminal.

Input: structured generated result data and audiovisual recommendation lists.

Server serializes these structures into a response format, attaches metadata such as timestamps and identifiers, and ensures size limits by truncating or compressing long sections if necessary.

Output: a serialized response message ready to be transmitted to the terminal.

### Step 14

Terminal receives the response, decodes it, and presents information to the user.

Terminal listens for a response from the server, reads the incoming data stream, and parses the serialized response into internal structures.

Input: response message containing generated result data and audiovisual recommendation information.

Terminal maps each section to a corresponding user interface component, such as a “Summary” panel, an “Advice” list, an “Audiovisual Recommendations” list, and a “Financial Guidance” section. Terminal renders the text and associated metadata on the display device, formats bullet points, and provides interactive elements (for example, buttons for “Save,” “Play,” “More details”).

Output: visual and interactive presentation of generated information and recommendations to the user on the display device.

### Step 15

User reviews the presented information and performs selections or evaluations.

User reads the summary, advice, and recommendations, and uses on-screen controls to select recommended content, save certain advice, or rate usefulness.

Input: visual information displayed on the terminal and interactive controls.

User actions generate selection events (for example, tapping on a recommended movie) and evaluation events (for example, pressing a “thumbs up” icon), which the terminal converts into structured feedback data.

Output: selection information and evaluation information represented as structured data within the terminal.

### Step 16

Terminal transmits selection information and evaluation information to the server.

Terminal packages user feedback events into a feedback request that includes identifiers for the relevant context, generated items, and timestamps.

Input: structured selection information and evaluation information stored in terminal memory.

Terminal serializes the feedback, opens a network connection to a feedback endpoint on the server, and transmits the data.

Output: network packets containing feedback data delivered to the server.

### Step 17

Server updates context information and history information based on user feedback.

Server receives feedback data, parses it, and identifies the corresponding context record and content items.

Input: feedback data containing selection information and evaluation information.

Server writes new entries into history tables (for example, viewing history, advice acceptance history) and updates fields in the context record (for example, preference scores for certain subject categories). The server may recompute summary statistics and feature vectors that represent user preferences.

Output: updated context records and history records that reflect the user's interactions.

### Step 18

Server refines subsequent processing using updated context and history.

Server uses the updated context information and history features for future sessions to adjust prompt template selection, context field weighting, and search ranking parameters.

Input: modified context information and recomputed preference features.

Server modifies rule parameters or internal weights that influence which context fields are included in future prompt sentences and how audiovisual results are ranked, thereby improving relevance and reducing unnecessary computation.

Output: adjusted internal configuration and behavior of the server that will affect prompt sentence generation and generative AI model interaction in subsequent runs.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

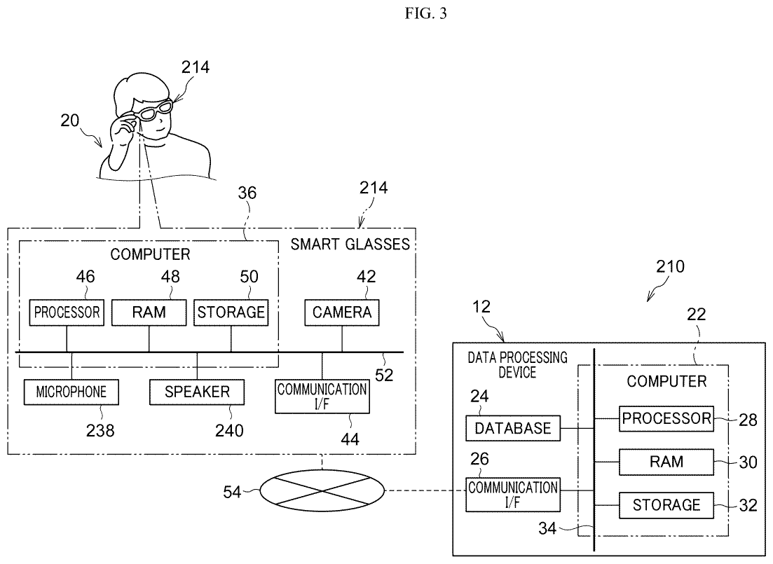

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

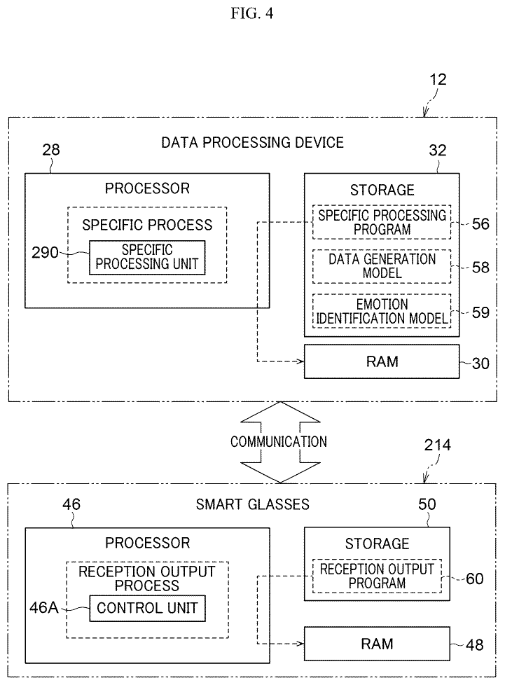

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

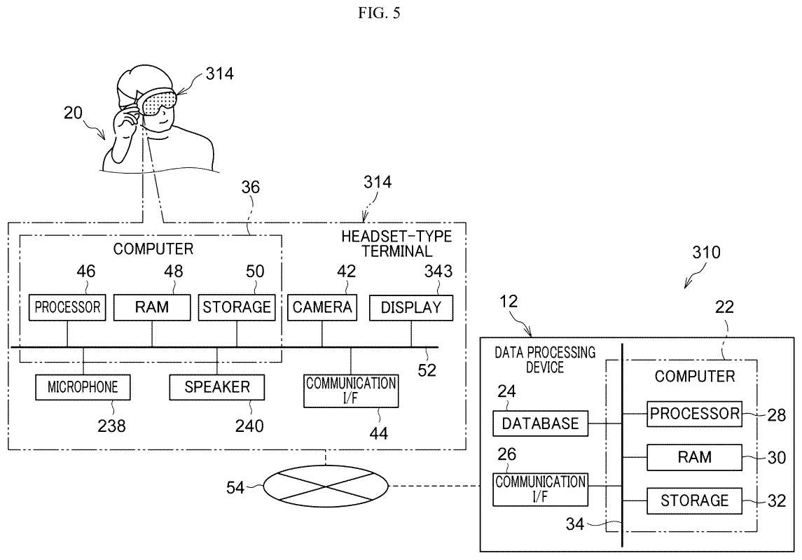

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

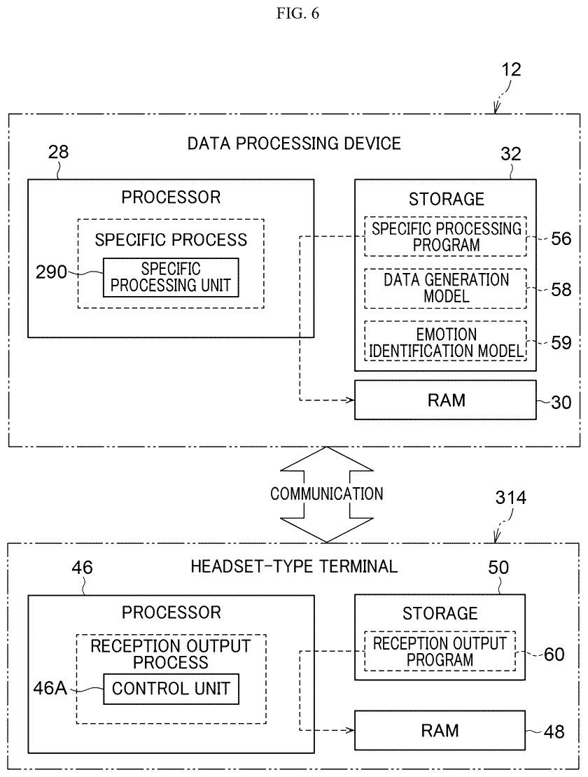

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

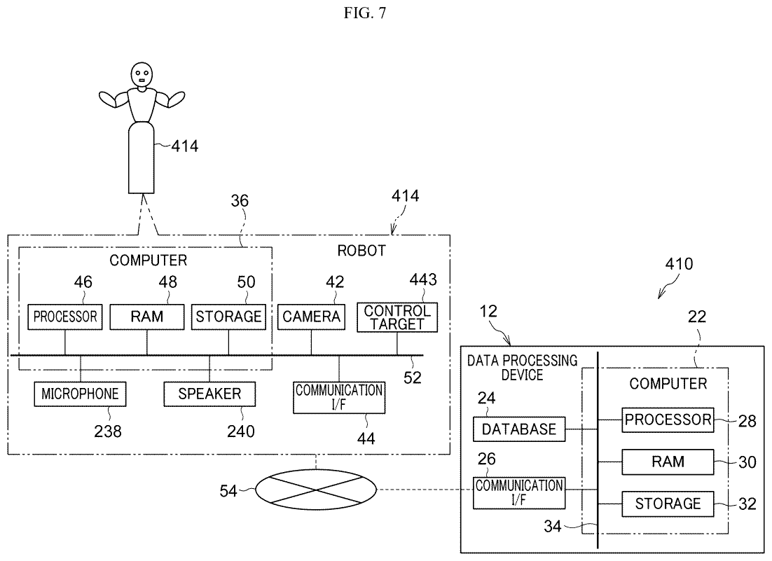

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

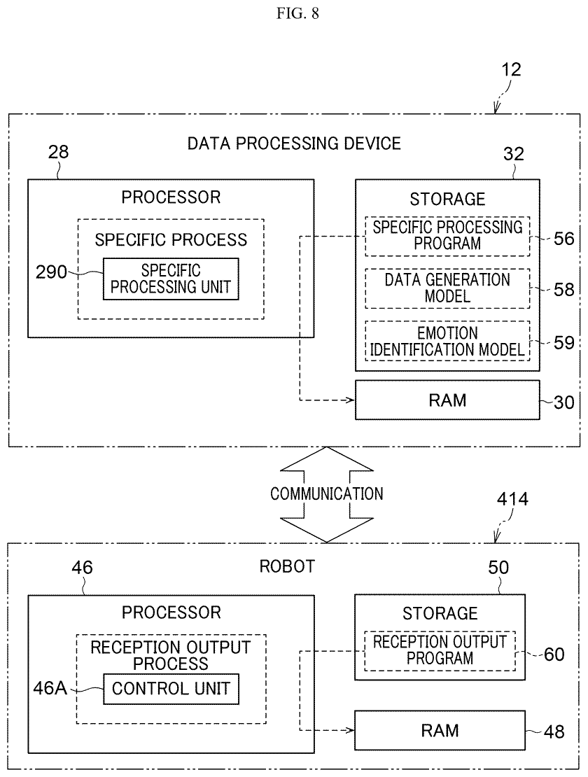

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

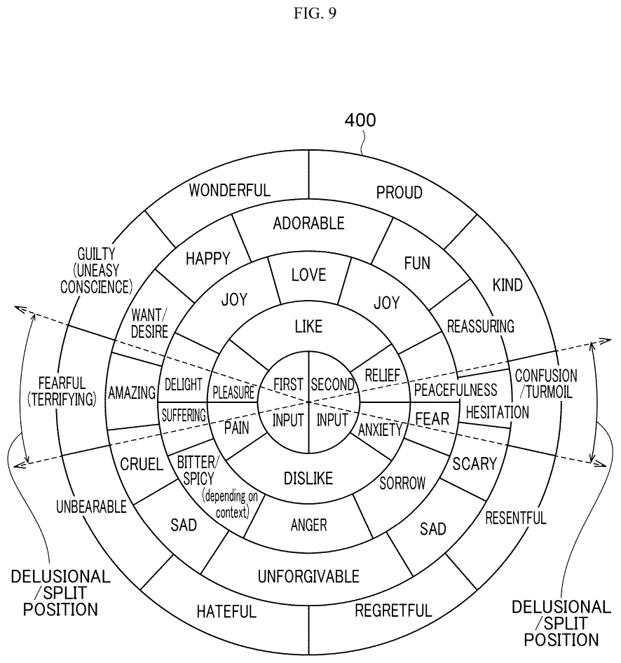

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

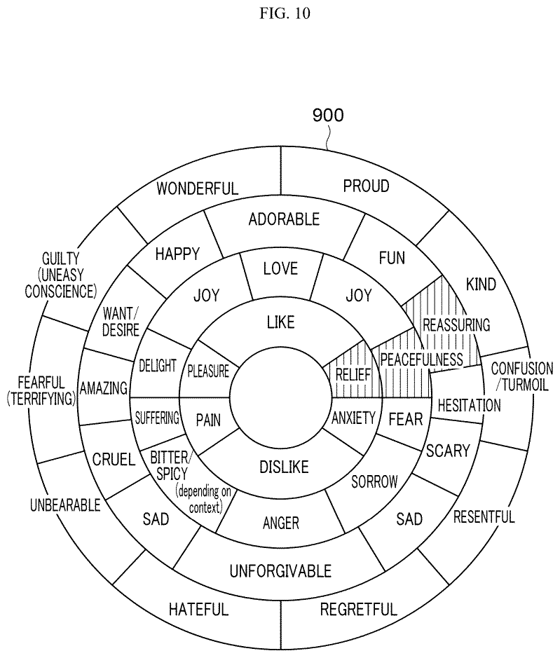

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device, and a display device,
wherein the processor is configured to
receive, via an input screen generated on the display device, identification information and associated information regarding an information medium that a user has consumed or intends to consume, and acquire the identification information and the associated information through the input screen,
structure the acquired identification information and the associated information and store the structured information as relational data in the storage device, and execute query processing on the relational data based on a search condition to extract relational data corresponding to the information medium,
generate, based on the extracted relational data and context information including a prompt sentence input by the user, a generation instruction prompt that instructs generation of summary information, opinion information, or advice information, and input the generation instruction prompt to a generative AI model, and
acquire the summary information, the opinion information, or the advice information output from the generative AI model, convert the acquired information into display data that is editable by the user, present the display data on the display device, update the display data in response to an edit operation by the user, and store updated display data as part of the relational data in the storage device.

### Supplementary 2

The system according to supplementary 1,
wherein the processor is configured to
acquire a behavioral goal or a learning goal set by the user from the storage device, generate, based on a combination of the behavioral goal or the learning goal and the summary information, an advice generation prompt that instructs generation of specific action plans adapted to a situation of the user, input the advice generation prompt to the generative AI model, acquire the action plans output from the generative AI model, present the action plans on the display device, and store the action plans as part of the relational data in the storage device.

### Supplementary 3

The system according to supplementary 1,
wherein the processor is configured to
acquire past usage history, input history, or behavior history of the user from the storage device, generate, based on context information including the past history and the summary information regarding the information medium, a goal proposal prompt that instructs proposal of new goal candidates suitable for the user, input the goal proposal prompt to the generative AI model, acquire the goal candidates output from the generative AI model, present the goal candidates on the display device, and register, as goal data in the storage device, at least one of the goal candidates in response to a selection or confirmation operation by the user.

### Application Example 1

### Supplementary 1

A system comprising a processor and a storage device,
wherein the processor is configured to
receive, from a terminal, attribute information and impression information regarding an information medium that a user has read or intends to read, the attribute information including at least one of a title, an author identifier, a classification identifier, or a genre identifier, and the impression information including at least one of a summary text or an opinion text, and store the attribute information and the impression information in the storage device,
generate, based on the attribute information and the impression information stored in the storage device, a prompt sentence for causing a generative AI model to analyze contents of the information medium and preferences of the user, and input the prompt sentence into the generative AI model to acquire generated information including a recommendation result for related information resources,
identify, based on the generated information, the related information resources, acquire past behavior information and context information of the user from the storage device, and generate recommendation information by selecting or ranking the related information resources using the past behavior information and the context information,
transmit the recommendation information to the terminal, and cause the recommendation information to be presented to the user via a display device of the terminal, and acquire, from the terminal, selection operation information indicating an operation performed by the user on at least one of the related information resources included in the recommendation information, store the selection operation information as feedback information in the storage device, and adapt at least one of subsequent generation of the prompt sentence and subsequent selection or ranking of the related information resources based on the feedback information.

### Supplementary 2

The system according to supplementary 1,
wherein the processor is configured to
generate, as the prompt sentence, instruction information that causes the generative AI model to change advice contents and recommendation policies for the related information resources in accordance with the past behavior information and the context information of the user, and input the instruction information into the generative AI model to dynamically vary the advice contents and the recommendation policies.

### Supplementary 3

The system according to supplementary 1,
wherein the processor is configured to
acquire, from the storage device, the past behavior information and the context information of the user, generate, as the prompt sentence, instruction information that causes the generative AI model to propose at least one of an achievement target or an action policy related to the related information resources based on the past behavior information and the context information, and input the instruction information into the generative AI model to propose the at least one of the achievement target or the action policy to the user.

### Example 2

### Supplementary 1

A system comprising a processor,
wherein the processor is configured to
cause a terminal to acquire character information relating to a publication from a user via an input interface as book information,
perform, in an information processing apparatus, natural language preprocessing on the character information relating to the publication, the natural language preprocessing including at least morphological segmentation, removal of non-informative terms, and normalization of word forms, and generate a first prompt sentence that instructs a generative AI model to extract one or more main themes and one or more messages of the publication by using at least the preprocessed character information, and input the first prompt sentence into the generative AI model to obtain the one or more main themes and the one or more messages of the publication,
generate, in the information processing apparatus, a second prompt sentence that, based on the one or more main themes and the one or more messages obtained from the generative AI model, instructs the generative AI model to generate a summary sentence representing contents of the publication and advice information relating to goal setting and behavioral guidelines for the user, and input the second prompt sentence into the generative AI model to obtain the summary sentence and the advice information, and
cause the terminal to present the summary sentence and the advice information to the user via a display device.

### Supplementary 2

The system according to supplementary 1,
wherein the processor is configured to
acquire behavioral information and situational information of the user from a storage device, generate a third prompt sentence that, based on the behavioral information, the situational information, and the one or more main themes and the one or more messages of the publication obtained from the generative AI model, instructs the generative AI model to modify contents of the advice information according to the behavioral information and the situational information of the user, input the third prompt sentence into the generative AI model to obtain adapted advice information, and cause the terminal to present the adapted advice information to the user via the display device.

### Supplementary 3

The system according to supplementary 1,
wherein the processor is configured to
acquire past behavioral information and past situational information of the user from a storage device, generate a fourth prompt sentence that, based on the past behavioral information, the past situational information, and the one or more main themes and the one or more messages of the publication obtained from the generative AI model, instructs the generative AI model to propose at least one goal to be achieved by the user and at least one concrete action plan corresponding to the goal, input the fourth prompt sentence into the generative AI model to obtain the at least one goal and the at least one concrete action plan, and cause the terminal to present the at least one goal and the at least one concrete action plan to the user via the display device.

### Application Example 2

### Supplementary 1

A system comprising a processor,
wherein the processor is configured to
acquire, via an information input interface, information regarding a written work read or to be read by a user and information regarding a goal of the user, and store the acquired information in a storage device,
perform natural language processing on character string data included in the information regarding the written work to extract subject information and message information of the written work and store the extracted subject information and message information in the storage device,
acquire emotion-related information from the user, estimate emotion state information of the user on the basis of the emotion-related information and the information regarding the written work, and store the emotion state information in the storage device, generate context information including at least the subject information of the written work, the message information of the written work, the information regarding the goal of the user, and the emotion state information of the user,
generate, on the basis of the context information, a prompt sentence that instructs execution of at least one process among a summary generation process, an advice generation process, a recommendation generation process, and a financial guidance generation process, input the prompt sentence into a generative AI model provided by an external computing device, cause the generative AI model to execute text generation processing, and acquire, as generated result data, at least one kind of information among summary information of the written work, advice information for the user, recommendation information of content, and financial behavior guidance information,
execute a search process on an information storage device that stores audiovisual content, on the basis of at least the subject information of the written work and the emotion state information of the user, and acquire recommendation information of related audiovisual content, and
present, via a display device, at least one of the generated result data and the recommendation information of the audiovisual content to the user, and acquire selection information or evaluation information from the user and store the selection information or the evaluation information as part of the context information in the storage device.

### Supplementary 2

The system according to supplementary 1,
wherein the processor is configured to
transmit at least one of audio data acquired from an audio input device and character string data acquired from a character input device to an external analysis service, acquire a result of emotion analysis from the external analysis service, determine the emotion state information of the user on the basis of the result of the emotion analysis, and change an instruction content and an expression style of the prompt sentence according to the emotion state information so that the advice information generated by the generative AI model is adapted to the emotion state of the user.

### Supplementary 3

The system according to supplementary 1,
wherein the processor is configured to
acquire history information including at least one of reading history information, viewing history information, purchase history information, and past emotion state information of the user from a history information storage device, and, on the basis of the history information, the subject information of the written work, and the information regarding the goal of the user, generate a prompt sentence that instructs the generative AI model to generate at least one among a goal proposal, an action plan proposal, a saving guidance proposal, and an investment guidance proposal, input the prompt sentence into the generative AI model, and propose to the user new goal information or behavior guidance information adapted to the user.

What is claimed is:

1. A system comprising:
circuitry configured to:
receive, via a communication interface coupled to a packet-switched network, identification information and associated information regarding an information medium from a terminal device;
structure the received identification information and associated information and store the structured information as relational data in a storage device;
execute query processing on the relational data based on a search condition to extract relational data corresponding to the information medium;
generate, based on the extracted relational data and context information including a prompt sentence received from the terminal device, a generation instruction prompt that instructs generation of at least one of summary information, opinion information, or advice information, and input the generation instruction prompt to a generative neural network model;
acquire the generated output from the generative neural network model, convert the generated output into display data, transmit the display data to the terminal device via the communication interface, receive an edit operation from the terminal device, and store updated display data as part of the relational data in the storage device.

2. The system according to claim 1, wherein the circuitry is configured to structure the identification information and associated information by mapping the received fields to a relational schema including a medium identifier field, an attribute field, an impression text field, and a timestamp field, and storing the structured record in the storage device with indexing on the identifier field and attribute fields.

3. The system according to claim 2, wherein the circuitry is configured to execute the query processing by constructing a parameterized query from the search condition, executing the query against the relational data, and ranking retrieved records by relevance score based on attribute matching and timestamp recency.

4. The system according to claim 3, wherein the circuitry is configured to generate the generation instruction prompt by organizing the extracted relational data and the context information into sections including an instruction portion specifying output type, length, and format, and a context portion containing the relational data and user-provided prompt sentence.

5. The system according to claim 1, wherein the circuitry is configured to acquire a goal or a learning objective stored in the storage device in association with a user identifier, generate an advice generation prompt based on a combination of the goal and the generated summary information that instructs generation of specific action plans adapted to a situation of the user, input the advice generation prompt to the generative neural network model, acquire the action plans, transmit the action plans to the terminal device, and store the action plans as part of the relational data in the storage device.

6. The system according to claim 5, wherein the circuitry is configured to generate the advice generation prompt by constructing a structured instruction that specifies the user's goal, the summary information, contextual constraints including time and resource availability, and an instruction to generate actionable steps adapted to the specified constraints.

7. The system according to claim 1, wherein the circuitry is configured to retrieve past usage history, input history, or behavioral history of the user from the storage device, generate a goal proposal prompt based on the past history and the summary information that instructs proposal of new goal candidates suitable for the user, input the goal proposal prompt to the generative neural network model, acquire goal candidates, transmit the goal candidates to the terminal device, and register at least one selected goal candidate as goal data in the storage device.

8. The system according to claim 7, wherein the circuitry is configured to construct the goal proposal prompt by analyzing patterns in the past history to identify interests and behavioral trends, encoding the identified patterns as context in the goal proposal prompt, and instructing the generative neural network model to propose goals aligned with the identified patterns.

9. The system according to claim 1, wherein the circuitry is configured to receive attribute information and impression information from the terminal device, generate a prompt sentence for causing the generative neural network model to analyze content of the information medium and preferences of the user, acquire a recommendation result for related information resources, and transmit the recommendation result to the terminal device via the communication interface.

10. The system according to claim 9, wherein the circuitry is configured to identify related information resources based on the recommendation result, retrieve past behavioral history and preference information from the storage device, generate a personalized recommendation ranking using the retrieved history, and store the recommendation ranking in the storage device in association with the user identifier.

11. The system according to claim 9, wherein the circuitry is configured to compute vector embeddings for stored relational data records using a pre-trained encoder, construct a vector search index, and identify related information resources by computing similarity between an embedding of the information medium and stored embeddings in the vector search index.

12. The system according to claim 1, wherein the circuitry is configured to acquire behavioral history including interaction data indicating which portions of the display data the user modified, and incorporate the behavioral history as additional context in subsequently generated generation instruction prompts to adapt output to the user's editing preferences.

13. The system according to claim 12, wherein the circuitry is configured to detect a pattern in the behavioral history indicating systematic additions or deletions to generated output, and update a prompt template stored in the storage device to pre-incorporate the detected patterns as constraints in the generation instruction prompt.

14. The system according to claim 1, wherein the circuitry is configured to monitor a content coverage metric indicating the proportion of key attributes of the information medium addressed in the generated output, and when the coverage metric falls below a threshold, generate a supplemental prompt instructing the generative neural network model to address uncovered attributes, and transmit supplemental output to the terminal device.

15. The system according to claim 1, wherein the circuitry is configured to store the generation instruction prompt and the generated output as history data in the storage device, and upon receiving a subsequent prompt sentence from the terminal device for the same or a related information medium, retrieve relevant history data and incorporate it as additional context in the generation instruction prompt to improve output consistency.

16. The system according to claim 15, wherein the circuitry is configured to detect similarity between the subsequent prompt sentence and historical prompt sentences using a vector-space similarity metric, and select relevant history data based on the similarity score before constructing the generation instruction prompt.

17. The system according to claim 1, wherein the circuitry is configured to generate a progress report based on accumulated relational data, goal data, and action plan records for a user identifier, construct a report generation prompt, input the report generation prompt to the generative neural network model, and transmit the resulting progress report to the terminal device via the communication interface.

18. A system comprising:
circuitry configured to:
receive, via a communication interface coupled to a packet-switched network, identification information and associated information for an information medium from a terminal device, structure the received information as relational data, and store the relational data in a storage device;
execute query processing on the relational data to extract records corresponding to the information medium, and generate a generation instruction prompt specifying output type, length, and format based on the extracted records and a context prompt received from the terminal device;
input the generation instruction prompt to a generative neural network model and acquire generated output including at least one of summary information, opinion information, or advice information;
retrieve past usage history and behavioral history from the storage device, generate a goal proposal prompt based on the past history and the generated summary information, input the goal proposal prompt to the generative neural network model, acquire goal candidates, and store selected goal candidates as goal data in the storage device; and
transmit the generated output and goal candidates to the terminal device via the communication interface, receive edit operations from the terminal device, and store updated display data as part of the relational data in the storage device.

19. The system according to claim 18, wherein the circuitry is configured to compute vector embeddings for stored relational data records, construct a vector search index, and identify related information resources by computing similarity between an embedding of the information medium and stored embeddings.

20. A method comprising:
receiving, via a communication interface coupled to a packet-switched network, identification information and associated information regarding an information medium from a terminal device;
structuring the received identification information and associated information and storing the structured information as relational data in a storage device;
executing query processing on the relational data based on a search condition to extract relational data corresponding to the information medium;
generating, based on the extracted relational data and context information including a prompt sentence received from the terminal device, a generation instruction prompt that instructs generation of at least one of summary information, opinion information, or advice information, and inputting the generation instruction prompt to a generative neural network model;
acquiring generated output from the generative neural network model, converting the generated output into display data, transmitting the display data to the terminal device via the communication interface, receiving an edit operation from the terminal device, and storing updated display data as part of the relational data in the storage device.
